(19) United States
(12) Patent Application Publication
(10) Pub. No.: US 2010/0020215 A1
(43) Pub. Date: Jan. 28, 2010

(54) SOLID-STATE IMAGE CAPTURING DEVICE, METHOD FOR MANUFACTURING THE SAME AND ELECTRONIC INFORMATION DEVICE

(75) Inventor: Tomohiro Konishi, Yamatokoriyama-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-shi, Osaka (JP)

(21) Appl. No.: 11/992,668

(22) PCT Filed: Sep. 8, 2006
(86) PCT No.: PCT/JP2006/317905

§ 371 Date: Oct. 2, 2009

(30) Foreign Application Priority Data
Sep. 30, 2005 (JP) 2005-288719

(51) Int. Cl. H04N 5/335

(52) U.S. Cl. 348/302; 348/E05.091

(57) ABSTRACT

A decrease in a light receiving sensitivity at a peripheral portion of an image capturing area is suppressed, thereby obtaining a solid-state image capturing device with an excellent luminance shading characteristic. In a solid-state image capturing device in which an image capturing area 1 is structured having a plurality of light receiving sections 12 arranged at a top portion of a semiconductor substrate 11 in a two-dimensional array; metal wirings 14 and 15 of a plurality of layers of wirings is provided to avoid areas above the light receiving sections 12; and the plurality of layers of wirings are connected to via contact sections, a position of each metal wiring 15 of the uppermost layer and each via contact 16 relative to a unit pixel (light receiving section 12) is designed offset so as to be closer to the center of the image capturing area 1 as an observed portion of the image capturing area 1 moves from a central portion 2 toward peripheral portions 3 and 4 of the image capturing area 1. A position of each metal wiring 15 of an uppermost layer relative to a unit pixel is arranged offset so as to be closer to the center of the image capturing area 1 as an observed portion of the image capturing area moves from the central portion 2 toward the peripheral portions 3 and 4 of the image capturing area 1, without changing a wiring width of the metal wiring 15 of the uppermost layer and without a wiring width a corresponding metal wiring 14 of a lower layer.

### TECHNICAL FIELD

The present invention relates to: a solid-state image capturing device (e.g., CMOS image sensor) in which a decrease in a sensitivity as an observed portion of an image capturing area moves from a central portion toward a peripheral portion is reduced; a method for manufacturing the solid-state image capturing device; and an electronic information device (e.g., digital camera including digital movie camera and digital still camera, cell phone device and vehicle-mounted camera) using the solid-state image capturing device.

### BACKGROUND ART

In recent years, as an electronic information device, a solid-state image capturing device (e.g., CCD image sensor and CMOS image sensor) is not only used for digital camera purposes (e.g., digital movie camera and digital still camera), but also used for mobile device purposes (e.g., cell phone device) and for vehicle-mounted camera purposes and monitoring camera purposes. Particularly, regarding the CMOS image sensor, an amount of use thereof in mobile device purposes (e.g., cell phone device) has been significantly growing owing to an improvement of energy saving and image quality performance.

An image capturing area of the CCD image sensor is structured by having a plurality of light receiving sections (unit pixels) (e.g., PD (photodiode)) arranged on a semiconductor substrate in a two-dimensional array. In this CCD image sensor, light incident onto each pixel unit is photo-electrically converted by a PD (photodiode) (which is a light receiving section), so that a signal charge is generated for each pixel. Then, this signal charge is data-transferred via a vertical CCD transfer section and a horizontal CCD transfer section to an FD (floating diffusion) section, which is provided at an output section. Change of potential at this FD section is detected by a MOS transistor and converted into an electronic signal. The converted electronic signal is amplified and output as an image capturing signal.

In contrast, an image capturing area of the CMOS image sensor is structured by having a plurality of light receiving sections (unit pixels) (e.g., PD) arranged on a semiconductor substrate in a two-dimensional array. In each unit pixel, an FD section and a variety of transistors, such as for transfer and amplification, are provided. In this CMOS image sensor, light (subject light) incident onto each unit pixel is photo-electrically converted by the light receiving section (PD), so that a signal charge is generated. Then, this signal charge is transferred to the FD section by the transfer transistor. Change of potential at this FD section is detected by the amplification transistor and converted into an electronic charge. The converted electronic signal is amplified and a signal for each pixel is output from a signal line.

In this CMOS image sensor, a plurality of layers of metal wirings including aluminum and the like is provided on the substrate in order to drive the transfer transistor, the amplification transistors and the like. These layers of metal wirings are provided so as to avoid areas above the light receiving sections such that an aperture ratio of the light receiving section is increased and an increased amount of light is incident onto the light receiving section. Further, an on-chip lens is arranged above these layers of metal wirings so as to improve the aperture ratio.

In the mobile device purposes (e.g., cell phone device), it is important to miniaturize and reduce the profile of the device. Accordingly, advancements in miniaturization and profile reduction of an optical lens system is progressing. As a result, in order to realize the miniaturization and profile reduction of the optical system, a distance to a lens when viewed from an image sensor (e.g., exit pupil position) is shortened.

As the distance between the lens and the image sensor becomes closer, an angle of light incident onto a pixel section naturally becomes larger at a peripheral portion of an image capturing area (peripheral portion distant from a central portion of a substrate) in the image sensor. In order to address this increasing angle of light incident onto the pixel section, a conventional CMOS image sensor is designed such that a position of each microlens or each layer of metal wiring relative to a unit pixel is offset in a direction so as to be closer to the center of the image capturing area as an observed portion of the image capturing area moves from the central portion toward the peripheral portion of the image capturing area, as disclosed, for example, in Reference 1. Hereinafter, a CMOS image sensor disclosed in Reference 1 will be described in detail with reference to Portions (a-1) and (a-2) of FIG. 11 to Portions (c-1) and (c-2) of FIG. 11.

FIG. 11 is a diagram for describing an exemplary structure of a conventional CMOS image sensor. Portion (a-2) of FIG. 11 is a cross-sectional view of a unit pixel section at a central portion of an image capturing area shown in Portion (a-1) of FIG. 11. Portion (b-2) of FIG. 11 is a cross-sectional view of a unit pixel section at a middle portion between the central portion and an outermost periphery of an image capturing area shown in Portion (b-1) of FIG. 11. Portion (c-2) of FIG. 11 is across-sectional view of a unit pixel section at the outermost periphery of an image capturing area shown in Portion (c-1) of FIG. 11.

In Portions (a-1) and (a-2) of FIG. 11 to Portions (c-1) and (c-2) of FIG. 11, in this CMOS image sensor, light receiving sections 12 are provided at an upper portion of a semiconductor substrate 11, and a plurality of layers of metal wirings 13 to 15 is provided above this semiconductor substrate 11 so as to avoid areas above the light receiving sections 12. Microlenses 20 are arranged above the semiconductor substrate 11 in order to focus light onto the respective light receiving sections 12. A plurality of unit pixel sections (light receiving sections) is provided in an image capturing area 1 of the CMOS image sensor in a two-dimensional array.

As shown in Portions (a-1) and (a-2) of FIG. 11 to Portions (c-1) and (c-2) of FIG. 11, the CMOS image sensor is structured such that a position of each microlens 20 and each metal wiring 15 of an uppermost layer relative to a unit pixel (light receiving section 12) is proportionally offset in a direction so as to be closer to the center of the image capturing area 1 as an observed portion of the image capturing area 1 moves from the central portion toward of the peripheral portion the image capturing area 1.

A pixel arranged at the central portion 2 of the image capturing area 1 shown in Portion (a-2) of FIG. 11 has an area with no metal wiring present above the light receiving section 12, and the microlens 20 is provided above this area. In the central portion 2 of this image capturing area 1, major optical element is incident in an approximately vertical direction (one direction in a plan view). Thus, the light passes through the area with no metal wiring and is incident onto the light receiving section 12.

In a pixel arranged at peripheral portions 3 and 4 which are distant from the central portion 2 of the image capturing area 1 shown in Portions (b-2) and (c-2) of FIG. 11, the mircolens 20 and the metal wiring 15 of the uppermost layer are provided angularly offset above the light receiving section 12. As a result, even when light is incident in an angular direction, the light passes through the area with no metal wiring and is incident onto the light receiving section 12.

Therefore, according to the structure of the conventional CMOS image sensor described above, at the peripheral portion of the image capturing area 1, light incident from a diagonal direction is prevented from being blocked by the metal wiring 15, thereby the light being focused near the center of a light receiving section 12.

Reference 1: Japanese Laid-Open Publication No. 2003-273342

### DISCLOSURE OF THE INVENTION

However, the conventional CMOS image sensor described above has a problem that sensitivity at the peripheral portions 3 and 4 of the image capturing area 1 decreases and luminance shading increases. Hereinafter, this problem will be described in detail with reference to Portions (a-1) and (a-2) of FIG. 12 to (c-1) and (c-2) of FIG. 12 and Portions (a-1) and (a-2) of FIG. 13 to (d-1) and (d-2) of FIG. 13.

FIG. 12 is a diagram for describing the problem of the conventional CMOS image sensor. Portion (a-2) of FIG. 12 is a plan view of a unit pixel section at a central portion of an image capturing area shown in Portion (a-1) of FIG. 12. Portion (b-2) of FIG. 12 is a plan view of a unit pixel section at a middle portion between the central portion and an outermost periphery of an image capturing area shown in Portion (b-1) of FIG. 12. Portion (c-2) of FIG. 12 is a plan view of a unit pixel section at the outermost periphery of an image capturing area shown in Portion (c-1) of FIG. 12.

In Portions (a-1) and (a-2) of FIG. 12 to (c-1) and (c-2) of FIG. 12, in the CMOS image sensor, metal wirings 15 of an uppermost layer are arranged in a lattice pattern to avoid areas above light receiving sections 12, and metal wirings 14 of a second layer are arranged in a vertical direction (up-and-down direction in a plan view; one direction). Both the metal wirings 14 and 15 are connected to each other by way of via contacts 16. A position of each metal wiring 15 of the uppermost layer relative to a unit pixel (light receiving section 12) is proportionally offset in a direction so as to be closer to the central portion 2 of the image capturing area 1 as an observed portion of the image capturing area 1 moves from the central portion 2 toward the peripheral portions 3 and 4 of the image capturing area 1. In Portions (b-2) and (c-2) of FIG. 12, a dotted line 15A indicates a position of a metal wiring 15 of the uppermost layer prior to the offset thereof, and solid lines 15B and 15C indicates a position of a metal wiring 15 of the uppermost layer after the offset thereof, respectively.

In general, the metal wirings 15 of the uppermost layer are used for application of supply voltage and the metal wirings 15 are connected by way of the via contacts 16 to the metal wirings 14 of a second layer located at a lower layer with respect to the metal wirings 15 of the uppermost layer. Accordingly, no limitation is imposed on a position of each metal wiring 15 of the uppermost layer relative to a pixel unit being offset as an observed portion of the image capturing area 1 moves from the central portion 2 toward the peripheral portion 4 of the image capturing area 1, which is as described above, as long as the metal wiring 15 of the uppermost layer is connected to the metal wiring 14 of the second layer.

In contrast, it is difficult to offset a position of each metal wiring 14 of the second layer relative to a unit pixel wherein the metal wiring 14 is located at the lower layer with respect to the metal wiring 15 of the uppermost layer since the metal wiring 14 of the second layer is connected to a metal wiring 13 so as to make up a circuit wherein the metal wiring 13 is located further lower layer with respect to the metal wiring 15 of the uppermost layer.

In the case where a position of a metal wiring 14 of the second layer cannot be moved, it is necessary to enlarge portions of the metal wirings 15B and 15C of the uppermost layer and arrange wiring patterns on the via contacts 16 at the peripheral positions 3 and 4 other than at the central portion 2 of the image capturing area 1, as shown, for example, in Portions (b-2) and (c-2) of FIG. 12.

As described above, when the portion of each of the metal wirings 15B and 15C of the uppermost layer is enlarged, a size of an opening of each of the metal wirings 15B and 15C is reduced. As a result, light is partially blocked by the metal wirings 15B and 15C at the peripheral portions 3 and 4 of the image capturing area 1 and/or a light receiving sensitivity of the light receiving section 12 is reduced due to a diffused reflection of the light on the metal wirings 15B and 15C. When the light receiving sensitivity is reduced at the peripheral portions 3 and 4 of the image capturing area 1, there occurs a problem that luminance shading increases due to a reduced light amount at the periphery.

Portion (a-2) of FIG. 13 is a cross-sectional view of A-A′ line in Portion (a-2) of FIG. 12 of a unit pixel section at the central portion 2 of the image capturing area 1 shown in Portion (a-1) of FIG. 13. Portion (b-2) of FIG. 13 is a cross-sectional view of B-B′ line in Portion (b-2) of FIG. 12 of a unit pixel section at a middle portion (peripheral portion 3) between the central portion 2 and the outermost periphery of the image capturing area 1 shown in Portion (b-1) of FIG. 13. Portions (c-2) and (d-2) of FIG. 13 are cross-sectional views of C-C′ and D-D′ lines in Portion (c-2) of FIG. 12 of a unit pixel section at the outermost periphery (peripheral portion 4) of the image capturing area 1 shown in Portions (c-1) and (d-1) of FIG. 13, respectively.

In Portions (a-1) and (a-2) of FIG. 13 to (d-1) and (d-2) of FIG. 13, light focused by the microlenses 20 in the metal wirings 15, 15B and 15C of the uppermost layer is wider than that focused by the microlenses in the metal wirings 13 and 14 located at lower layers with respect to the metal wirings 15, 15B and 15C. Therefore, the light receiving sensitivity is more greatly influenced in the case of the light focused by the microlenses 20 in the metal wirings 15, 15B and 15C than in the metal wirings 13 and 14.

Incident light is not blocked by the metal wirings 15, 15B and 15C of the uppermost layer, respectively, at the central portion 2 of the image capturing area 1 shown in Portion (a-2) of FIG. 13; at the middle portion (peripheral section 3) between the central portion 2 and the outermost periphery of the image capturing area 1 shown in Portion (b-2) of FIG. 13; and at the C-C′ line of the outermost periphery (peripheral portion 4) of the image capturing area 1 shown in Portion (c-2) of FIG. 13. However, incident light is blocked by the metal wiring 15C of the uppermost layer at the line D-D′ line of the outermost periphery (periphery portion 4) of the image capturing area 1 shown in Portion (d-2) of FIG. 13.

As described above, the reduced size of the opening by each of the metal wirings 15B and 15C of the uppermost layer leads to a reduced light receiving sensitivity at the peripheral portions 3 and 4 of the image capturing area 1, which results in an enormous problem for the luminance shading.

The present invention is intended to solve the problem described above. The objective of the present invention is to provide: a solid-state image capturing device for suppressing a reduction of a light receiving sensitivity at peripheral portions of an image capturing area so as to have an excellent luminance shading characteristic; a method for manufacturing the solid-state image capturing device; and an electronic information device (e.g., digital camera (including digital movie camera, digital still camera), cell phone device and vehicle-mounted camera) using the solid-state image capturing device.

A solid-state image capturing device according to the present invention is provided, in which an image capturing area is structured having a plurality of light receiving sections arranged at a top portion of a semiconductor substrate in a two-dimensional array, a plurality of layers of wirings is provided to avoid areas above the light receiving sections, the plurality of layers of wirings are connected to via contact sections, wherein an offset amount of a position of each wiring of at least an upper layer of the plurality of layers of wirings relative to a light receiving section increases as an observed portion of the image capturing area moves from a central portion toward a peripheral portion of the image capturing area, such that the plurality of layers of wirings is arranged not to block light incident onto the light receiving sections, and an offset amount of a position of each via contact section to connected to a wiring of the upper layer relative to a light receiving section increases as an observed portion of the image capturing area moves from the central portion toward the peripheral portion of the image capturing area, such that the via contact sections are arranged not to block the light incident onto the light receiving sections, thereby the objective described above being achieved.

Preferably, in a solid-state image capturing device according to the present invention, a position of each wiring of the upper layer relative to a light receiving section is arranged offset so as to be closer to the center of the image capturing area as an observed portion of the image capturing area moves from the central portion toward the peripheral portion of the image capturing area, and a position of each via contact section relative to a light receiving section is arranged offset so as to be closer to the center of the image capturing area as an observed portion of the image capturing area moves from the central portion toward the peripheral portion of the image capturing area.

Still preferably, in a solid-state image capturing device according to the present invention, wirings of the upper layer are arranged in an other direction or in a lattice pattern in a plan view, a position of each wiring of the upper layer relative to the light receiving section is arranged offset in one direction or in a radial direction from the center of the image capturing area in the plan view as an observed portion of the image capturing area moves from the central portion toward the peripheral portion of the image capturing area, and a position of each via contact section relative to the light receiving section is arranged offset in the one direction or the radial direction from the center of the image capturing area in the plan view as an observed portion of the image capturing area moves from the central portion toward the peripheral portion of the image capturing area, the via contact sections are connected to portions of the wirings of the upper layer arranged in the other direction in the plan view.

Still preferably, in a solid-state image capturing device according to the present invention, wirings of the upper layer are arranged in one direction or in a lattice pattern in a plan view, a position of each wiring of the upper layer relative to the light receiving section is arranged offset in an other direction or in a radial direction from the center of the image capturing area in the plan view as an observed portion of the image capturing area moves from the central portion toward the peripheral portion of the image capturing area, and a position of each via contact section relative to the light receiving section is arranged offset in the other direction or the radial direction from the center of the image capturing area in the plan view as an observed portion of the image capturing area moves from the central portion toward the peripheral portion of the image capturing area, the via contact sections are connected to portions of the wirings of the upper layer arranged in the one direction in the plan view.

Still preferably, in a solid-state image capturing device according to the present invention, an offset amount of the wiring of the upper layer in the one direction in the plan view and an offset amount of the via contact section in the one direction in the plan view match each other.

Still preferably, in a solid-state image capturing device according to the present invention, an offset amount of the wiring of the upper layer in the other direction in the plan view and an offset amount of the via contact section in the other direction in the plan view match each other.

Still preferably, in a solid-state image capturing device according to the present invention, a position of each wiring of a lower layer relative to a light receiving section does not change at the central portion and the peripheral portion of the image capturing area, wirings of the lower layer are connected to the wirings of the upper layer by way of the via contacts.

Still preferably, in a solid-state image capturing device according to the present invention, wirings of a lower layer are arranged in the one direction in the plan view, the wirings of the lower layer are connected to the wirings of the upper layer by way of the via contacts.

Still preferably, in a solid-state image capturing device according to the present invention, a length of a wiring of a lower layer in the one direction in the plan view is set at least longer than an offset amount of the wiring of the upper layer in the one direction in the plan view and longer than an offset amount of the via contact section in the one direction in the plan view, wirings of the lower layer are connected to the wirings of the upper layer by way of the via contact sections.

Still preferably, in a solid-state image capturing device according to the present invention, wirings of a lower layer are arranged in the other direction in the plan view, the wirings of the lower layer are connected to the wirings of the upper layer by way of the via contacts.

Still preferably, in a solid-state image capturing device according to the present invention, a length of a wiring of a lower layer in the other direction in the plan view is set at least longer than an offset amount of the wiring of the upper layer in the other direction in the plan view and longer than an offset amount of the via contact section in the other direction in the plan view, wirings of the lower layer are connected to the wirings of the upper layer by way of the via contact sections.

Still preferably, in a solid-state image capturing device according to the present invention, an offset amount of a position of each wiring of a lower layer relative to a light receiving section increases as an observed portion of the image capturing area moves from the central portion toward the peripheral portion of the image capturing area, such that the plurality of layers of wirings is arranged not to block light incident onto the light receiving sections, wirings of the lower layer are connected to the wirings of the upper layer by way of the via contact sections.

Still preferably, in a solid-state image capturing device according to the present invention, a length of the wiring of a lower layer in the one direction in the plan view is set at least longer than an offset amount of the wiring of the lower layer in the one direction in the plan view, wirings of the lower layer are connected to the wirings of the upper layer by way of the via contact sections.

Still preferably, in a solid-state image capturing device according to the present invention, a length of the wiring of a lower layer in the other direction in the plan view is set at least longer than an offset amount of the wiring of the lower layer in the other direction in the plan view, wirings of the lower layer are connected to the wirings of the upper layer by way of the via contact sections.

Still preferably, in a solid-state image capturing device according to the present invention, wirings of a lower layer connected to the wirings of the upper layer by way of the via contact sections include: portions, a position of each of which relative to a light receiving section is offset as an observed portion of the image capturing area moves from the central portion toward the peripheral portion of the image capturing area; and portions, a position of each of which relative to the light receiving section does not change at the central portion and the peripheral portion of the image capturing area.

Still preferably, in a solid-state image capturing device according to the present invention, the portions, a position of each of which does not change at the central portion and the peripheral portion of the image capturing area, protrude from the portions, a position of each of which is offset as an observed portion of the image capturing area moves from the central portion toward the peripheral portion of the image capturing area.

Still preferably, in a solid-state image capturing device according to the present invention, wirings of a lower layer connected to the wirings of the upper layer by way of the via contact sections include: portions, a position of each of which relative to a light receiving section is offset in one direction in a plan view as an observed portion of the image capturing area moves from the central portion toward the peripheral portion of the image capturing area; and portions, a position of each of which relative to the light receiving section is offset in an other direction in the plan view as an observed portion of the image capturing area moves from the central portion toward the peripheral portion of the image capturing area.

Still preferably, in a solid-state image capturing device according to the present invention, the portions offset in the one direction in the plan view protrude from the portions offset in the other direction in the plan view.

Still preferably, in a solid-state image capturing device according to the present invention, wirings of a lower layer connected to the wirings of the upper layer by way of the via contact sections include: portions, a position of each of which relative to a light receiving section is offset in one direction in a plan view as an observed portion of the image capturing area moves from the central portion toward the peripheral portion of the image capturing area; and portions, a position of each of which relative to the light receiving section is offset in an other direction in the plan view as an observed portion of the image capturing area moves from the central portion toward the peripheral portion of the image capturing area; and portions, a position of each of which relative to the light receiving section does not change at the central portion and the peripheral portion of the image capturing area.

Still preferably, in a solid-state image capturing device according to the present invention, a position of each via contact section offset relative to a light receiving section as an observed portion of the image capturing area moves from the central portion toward the peripheral portion of the image capturing area matches a position of each wiring of the lower layer offset relative to the light receiving section as an observed portion of the image capturing area moves from the central portion toward the peripheral portion of the image capturing area.

Still preferably, in a solid-state image capturing device according to the present invention, an offset amount of a position of each wiring of the upper layer offset in one direction in a plan view relative to a light receiving section as an observed portion of the image capturing area moves from the central portion toward the peripheral portion of the image capturing area matches an offset amount of a position of each via contact section offset in the one direction in the plan view relative to the light receiving section as an observed portion of the image capturing area moves from the central portion toward the peripheral portion of the image capturing area, the via contact sections are connected to portions of the wirings of the upper layer arranged in an other direction in the plan view; and an offset amount of a position of each wiring of the lower layer connected to the via contact sections offset in the other direction in the plan view relative to the light receiving section as an observed portion of the image capturing area moves from the central portion toward the peripheral portion of the image capturing area matches an offset amount of a position of each via contact section offset in the other direction in the plan view relative to the light receiving section as an observed portion of the image capturing area moves from the central portion toward the peripheral portion of the image capturing area, the via contact sections are connected to portions of the wirings of the lower layer arranged in the one direction in the plan view.

Still preferably, in a solid-state image capturing device according to the present invention, an offset amount of a position of each wiring of the upper layer offset in an other direction in a plan view relative to a light receiving section as an observed portion of the image capturing area moves from the central portion toward the peripheral portion of the image capturing area matches an offset amount of a position of each via contact section offset in the other direction in the plan view relative to the light receiving section as an observed portion of the image capturing area moves from the central portion toward the peripheral portion of the image capturing area, via contact sections are connected to portions of the wirings of the upper layer arranged in one direction in the plan view; and an offset amount of a position of each wiring of the lower layer connected to the via contact sections offset in the one direction in the plan view relative to the light receiving section as an observed portion of the image capturing area moves from the central portion toward the peripheral portion of the image capturing area matches an offset amount of a position of each via contact section offset in the one direction in the plan view relative to the light receiving section as an observed portion of the image capturing area moves from the central portion toward the peripheral portion of the image capturing area, the via contact sections are connected to portions of the wirings of the lower layer arranged in the other direction in the plan view.

Still preferably, in a solid-state image capturing device according to the present invention, a length of a portion of the wirings of the lower layer in the one direction of the plan view, in which the position of each of the portions of the lower layer relative to the light receiving section is offset in the other direction in the plan view as an observed portion of the image capturing area moves from the central portion toward the peripheral portion of the image capturing area, is set longer than an offset amount of the position of the via contact section offset in the one direction in the plan view relative to the light receiving section as an observed portion of the image capturing area moves from the central portion toward the peripheral portion of the image capturing area, the wirings of the lower layer connected to wirings of the upper layer by way of the via contact sections.

Still preferably, in a solid-state image capturing device according to the present invention, the wiring of the upper layer is a wiring of an uppermost layer of a plurality of layers of wirings.

Still preferably, in a solid-state image capturing device according to the present invention, the wiring of a lower layer is a wiring of a second layer from the top with respect to the wiring of the upper layer when the wiring of the upper layer is a wiring of a first layer from the top.

Still preferably, in a solid-state image capturing device according to the present invention, wirings of the upper layer are arranged in a lattice pattern, the via contacts are arranged at intersections between one direction of the wirings of the upper layer in a plan view and an other direction of the wirings of the upper layer in the plan view at the central portion of the image capturing area, and the via contact sections are arranged offset from the intersections as an observed portion of the image capturing area moves from the central portion toward the peripheral portion of the image capturing area.

Still preferably, in a solid-state image capturing device according to the present invention, a setup is conducted in accordance with a limitation of a mask-making device, the setup including a setting direction of the image capturing area; wiring directions of the plurality of layers of wirings; and an offsetting direction of a position relative to each unit pixel as an observed portion of the image capturing area moves from the central portion toward the peripheral portion of the image capturing area.

Still preferably, in a solid-state image capturing device according to the present invention, a wiring width of the wiring of the upper layer at the central portion of the image capturing area and a wiring width of the wiring of the upper layer at the peripheral portion of the image capturing match each other.

Still preferably, in a solid-state image capturing device according to the present invention, a wiring width of the wiring of a lower layer for the wiring of the upper layer at the central portion of the image capturing area matches a wiring width of the wiring of the lower layer for the upper layer at the peripheral portion of the image capturing.

Still preferably, a solid-state image capturing device according to the present invention includes an on-chip lens on an upper layer side of the plurality of layers of wirings for focusing light onto the light receiving sections, wherein a position of the on-chip lens relative to a light receiving section is offset so as to be closer to the center of the image capturing area as an observed portion of the image capturing area moves from the central portion toward the peripheral portion of the image capturing area.

An electronic information device according to the present invention is provided using the solid-state image capturing device described above for an image capturing section.

A method for manufacturing a solid-state image capturing device according to the present invention is provided, wherein the solid-state image capturing device is manufactured by conducting a setup in accordance with a limitation of a mask-making device, the setup including a setting direction of the image capturing area; wiring directions of the wirings of the plurality of layers; and an offsetting direction of a position relative to each unit pixel as an observed portion of the image capturing area moves from the central portion toward the peripheral portion of the image capturing area.

Owing to the structure described above, the function of the present invention will described.

According to the present invention, an image capturing area is structured by having a plurality of light receiving sections arranged at the top portion of a semiconductor substrate in a two-dimensional array. A plurality of layers of wirings is provided so as to avoid areas above these light receiving sections. In a solid-state image capturing device having the plurality of layers of wirings connected to each other by way of via contact sections, a position of each wiring of an upper layer relative to a light receiving section (unit pixel) is arranged offset in a vertical direction (or horizontal direction) so as to be closer to the center of the image capturing area as an observed portion of the image capturing area moves from the central portion toward the peripheral portion of the image capturing area, wherein the wiring of the upper layer is provided in an other direction in a plan view of a light receiving section (unit pixel) (or one direction in a plan view; an other direction is a horizontal direction and the one direction is a vertical direction, so that the other direction and one direction are perpendicular to each other) or a lattice pattern.

A position of each via contact section connected to a wiring of the upper layer relative to a unit pixel (light receiving section) is designed offset in a vertical direction (or horizontal direction) or in a radial direction from the center of the image capturing area so as to be closer to the center of the image capturing area as an observed portion of the image capturing area moves from the central portion toward the peripheral portion of the image capturing area. In this case, an offset amount of a wiring of the upper layer in the vertical direction (or horizontal direction) and an offset amount of a via contact section in the vertical direction (or horizontal direction) are designed to match each other.

In addition, wirings of a lower layer (e.g., wirings of a second layer) connected to wirings of an upper layer by way of via contacts section are designed to be arranged in a vertical direction (or horizontal direction), or a size (length) of a wiring of the lower layer in the vertical direction (or horizontal direction) is designed to be at least larger (longer) than an offset amount of a wiring of the upper layer and an offset amount of a via contact section in the vertical direction (or horizontal direction).

In this manner, a position of each wiring of an upper layer relative to a unit pixel (light receiving section) can be designed offset so as to be closer to the center of an image capturing area as an observed portion of the image capturing area moves from a central portion toward a peripheral portion of the image capturing area, without changing a wiring width (opening) of a wiring of the upper layer (e.g., wiring of an uppermost layer) and without changing a position of a corresponding wiring of the lower layer (e.g., wiring of a second layer).

Since an opening of a wiring of an upper layer at the peripheral portion is not reduced, a decrease in a light receiving sensitivity at the peripheral portion is small, thereby obtaining a solid-state image capturing device with excellent luminance shading.

A position of each wiring of the upper layer relative to a unit pixel (light receiving section 12) may be designed offset in the vertical direction (or horizontal direction) so as to be closer to the center of the image capturing area as an observed portion of the image capturing area moves from the central portion toward the peripheral portion of the image capturing area. In this case, as size (wiring width) of a wiring of the lower layer in the vertical direction (or horizontal direction) is designed at least larger than an offset amount of a wiring of the second layer in the vertical direction (or horizontal direction).

As a result, it is possible to connect a via contact section and a wiring of a lower layer, without changing the wiring width of the wiring of the lower layer.

In addition, a wiring of the lower layer may include a combination of a portion offset in the vertical direction, a portion offset in the horizontal direction and non-offset portion such that a position of each wiring of the lower layer relative to a unit pixel (light receiving section) is closer to the center of the image capturing area as an observed portion of the image capturing area moves from the central portion toward the peripheral portion of the image capturing area.

In manufacturing a solid-state image capturing device according to the present invention, following setups can be conducted in accordance with a limitation of a mask-making device; a setting direction of an image capturing area, wiring directions of wirings of an upper layer and a lower layer and an offsetting direction of a position relative to each unit pixel (each light receiving section) as an observed portion of the image capturing area 1 moves from a central portion toward a peripheral portion of the image capturing area.

As described above, according to the present invention, a position of each wiring of the upper layer relative to a unit pixel (light receiving section) can be offset so as to be closer to the center of the image capturing area as an observed portion of the image capturing area moves from the central portion toward the peripheral portion of the image capturing area, without changing a wiring width of wirings of an uppermost layer and a wiring width of wirings of lower layers with respect to the uppermost layer at the central portion and at the peripheral portion of an image capturing area. Since an opening of a wiring at the peripheral portion of the image capturing area is not reduced, a decrease in a light receiving sensitivity at the peripheral portion of the image capturing area is suppressed, thereby obtaining a solid-state image capturing device with an excellent luminance shading characteristic.

### BRIEF DESCRIPTION OF THE DRAWINGS

FIG. 1 is a diagram showing an exemplary essential structure of a solid-state image capturing device according to Embodiment 1-1 of the present invention; Portion (a-2) of FIG. 1 is a plan view of a unit pixel section at a central portion of an image capturing area shown in Portion (a-1) of FIG. 1; Portion (b-2) of FIG. 1 is a plan view of a unit pixel section at a middle portion between the central portion and an outermost periphery of an image capturing area shown in Portion (b-1) of FIG. 1; and Portion (c-2) of FIG. 1 is a plan view of a unit pixel section at the outermost periphery of an image capturing area shown in Portion (c-1) of FIG. 1.

FIG. 2 is a diagram showing an exemplary essential structure of a solid-state image capturing device according to Embodiment 1-1 of the present invention; Portion (a-2) of FIG. 2 is a cross-sectional view of A-A′ line in Portion (a-2) of FIG. 1 of a unit pixel section at the central portion of the image capturing area shown in Portion (a-1) of FIG. 2; Portion (b-2) of FIG. 2 is a cross-sectional view of B-B′ line in Portion (b-2) of FIG. 1 of a unit pixel section at the middle portion between the central portion and the outermost periphery of the image capturing area shown in Portion (b-1) of FIG. 2; and Portions (c-2) and (d-2) of FIG. 2 are cross-sectional views of C-C′ and D-D′ lines in Portion (c-2) of FIG. 1 of a unit pixel section at the outermost periphery of the image capturing area shown in Portions (c-1) and (d-1) of FIG. 2, respectively.

FIG. 3 is a diagram showing an exemplary essential structure of a solid-state image capturing device according to Embodiment 1-2 of the present invention; Portion (a-2) of FIG. 3 is a plan view of a unit pixel section at a central portion of an image capturing area shown in Portion (a-1) of FIG. 3; Portion (b-2) of FIG. 3 is a plan view of a unit pixel section at a middle portion between the central portion and an outermost periphery of an image capturing area shown in Portion (b-1) of FIG. 3; and Portion (c-2) of FIG. 3 is a plan view of a unit pixel section at the outermost periphery of an image capturing area shown in Portion (c-1) of FIG. 3.

FIG. 4 is a diagram showing an exemplary essential structure of a solid-state image capturing device according to Embodiment 1-3 of the present invention; Portion (a-2) of FIG. 4 is a plan view of a unit pixel section at a central portion of an image capturing area shown in Portion (a-1) of FIG. 4; Portion (b-2) of FIG. 4 is a plan view of a unit pixel section at a middle portion between the central portion and an outermost periphery of an image capturing area shown in Portion (b-1) of FIG. 4; and Portion (c-2) of FIG. 4 is a plan view of a unit pixel section at the outermost periphery of an image capturing area shown in Portion (c-1) of FIG. 4.

FIG. 5 is a diagram showing an exemplary essential structure of a solid-state image capturing device according to Embodiment 1-4 of the present invention; Portion (a-2) of FIG. 5 is a plan view of a unit pixel section at a central portion of an image capturing area shown in Portion (a-1) of FIG. 5; Portion (b-2) of FIG. 5 is a plan view of a unit pixel section at a middle portion between the central portion and an outermost periphery of an image capturing area shown in Portion (b-1) of FIG. 5; and Portion (c-2) of FIG. 5 is a plan view of a unit pixel section at the outermost periphery of an image capturing area shown in Portion (c-1) of FIG. 5.

FIG. 6 is a diagram showing an exemplary essential structure of a solid-state image capturing device according to Embodiment 2-1 of the present invention; Portion (a-2) of FIG. 6 is a plan view of a unit pixel section at a central portion of an image capturing area shown in Portion (a-1) of FIG. 6; Portion (b-2) of FIG. 6 is a plan view of a unit pixel section at a middle portion between the central portion and an outermost periphery of an image capturing area shown in Portion (b-1) of FIG. 6; and Portion (c-2) of FIG. 6 is a plan view of a unit pixel section at the outermost periphery of an image capturing area shown in Portion (c-1) of FIG. 6.

FIG. 7 is a diagram showing an exemplary essential structure of a solid-state image capturing device according to Embodiment 2-1 of the present invention; Portion (a-2) of FIG. 7 is a cross-sectional view of A-A′ line in Portion (a-2) of FIG. 6 of a unit pixel section at the central portion of the image capturing area shown in Portion (a-1) of FIG. 7; Portion (b-2) of FIG. 7 is a cross-sectional view of B-B′ line in Portion (b-2) of FIG. 6 of a unit pixel section at the middle portion between the central portion and the outermost periphery of the image capturing area shown in Portion (b-1) of FIG. 7; and Portions (c-2) and (d-2) of FIG. 7 are cross-sectional views of C-C′ and D-D′ lines in Portion (c-2) of FIG. 6 of a unit pixel section at the outermost periphery of the image capturing area shown in Portions (c-1) and (d-1) of FIG. 7, respectively.

FIG. 8 is a diagram showing an exemplary essential structure of a solid-state image capturing device according to Embodiment 2-2 of the present invention; Portion (a-2) of FIG. 8 is a plan view of a unit pixel section at a central portion of an image capturing area shown in Portion (a-1) of FIG. 8; Portion (b-2) of FIG. 8 is a plan view of a unit pixel section at a middle portion between the central portion and an outermost periphery of an image capturing area shown in Portion (b-1) of FIG. 8; and Portion (c-2) of FIG. 8 is a plan view of a unit pixel section at the outermost periphery of an image capturing area shown in Portion (c-1) of FIG. 8.

FIG. 9 is a diagram showing an exemplary essential structure of a solid-state image capturing device according to Embodiment 2-3 of the present invention; Portion (a-2) of FIG. 9 is a plan view of a unit pixel section at a central portion of an image capturing area shown in Portion (a-1) of FIG. 9; Portion (b-2) of FIG. 9 is a plan view of a unit pixel section at a middle portion between the central portion and an outermost periphery of an image capturing area shown in Portion (b-1) of FIG. 9; and Portion (c-2) of FIG. 9 is a plan view of a unit pixel section at the outermost periphery of an image capturing area shown in Portion (c-1) of FIG. 9.

FIG. 10 is a diagram showing an exemplary essential structure of a solid-state image capturing device according to Embodiment 3 of the present invention; Portion (a-2) of FIG. 10 is a plan view of a unit pixel section at a central portion of an image capturing area shown in Portion (a-1) of FIG. 10; Portion (b-2) of FIG. 10 is a plan view of a unit pixel section at a middle portion between the central portion and an outermost periphery of an image capturing area shown in Portion (b-1) of FIG. 10; and Portion (c-2) of FIG. 10 is a plan view of a unit pixel section at the outermost periphery of an image capturing area shown in Portion (c-1) of FIG. 10.

FIG. 11 is a diagram showing an exemplary essential structure of a conventional solid-state image capturing device; Portion (a-2) of FIG. 11 is a plan view of a unit pixel section at a central portion of an image capturing area shown in Portion (a-1) of FIG. 11; Portion (b-2) of FIG. 11 is a plan view of a unit pixel section at a middle portion between the central portion and an outermost periphery of an image capturing area shown in Portion (b-1) of FIG. 11; and Portion (c-2) of FIG. 11 is a plan view of a unit pixel section at the outermost periphery of an image capturing area shown in Portion (c-1) of FIG. 11.

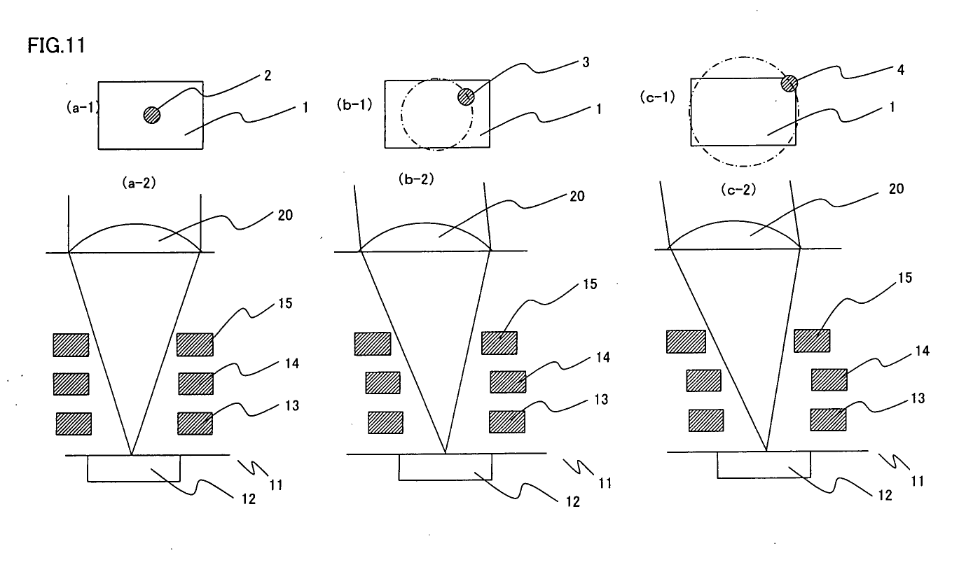

FIG. 12 is a diagram showing an exemplary essential structure of a conventional solid-state image capturing device; Portion (a-2) of FIG. 12 is a plan view of a unit pixel section at a central portion of an image capturing area shown in Portion (a-1) of FIG. 12; Portion (b-2) of FIG. 12 is a plan view of a unit pixel section at a middle portion between the central portion and an outermost periphery of an image capturing area shown in Portion (b-1) of FIG. 12; and Portion (c-2) of FIG. 12 is a plan view of a unit pixel section at the outermost periphery of an image capturing area shown in Portion (c-1) of FIG. 12.

FIG. 13 is a diagram showing an exemplary essential structure of a conventional solid-state image capturing device; Portion (a-2) of FIG. 13 is a cross-sectional view of A-A′ line in Portion (a-2) of FIG. 12 of a unit pixel section at the central portion of the image capturing area shown in Portion (a-1) of FIG. 13; Portion (b-2) of FIG. 13 is a cross-sectional view of B-B′ line in Portion (b-2) of FIG. 12 of a unit pixel section at the middle portion between the central portion and the outermost periphery of the image capturing area shown in Portion (b-1) of FIG. 13; and Portions (c-2) and (d-2) of FIG. 13 are cross-sectional views of C-C′ and D-D′ lines in Portion (c-2) of FIG. 12 of a unit pixel section at the outermost periphery of the image capturing area shown in Portions (c-1) and (d-1) of FIG. 13, respectively.

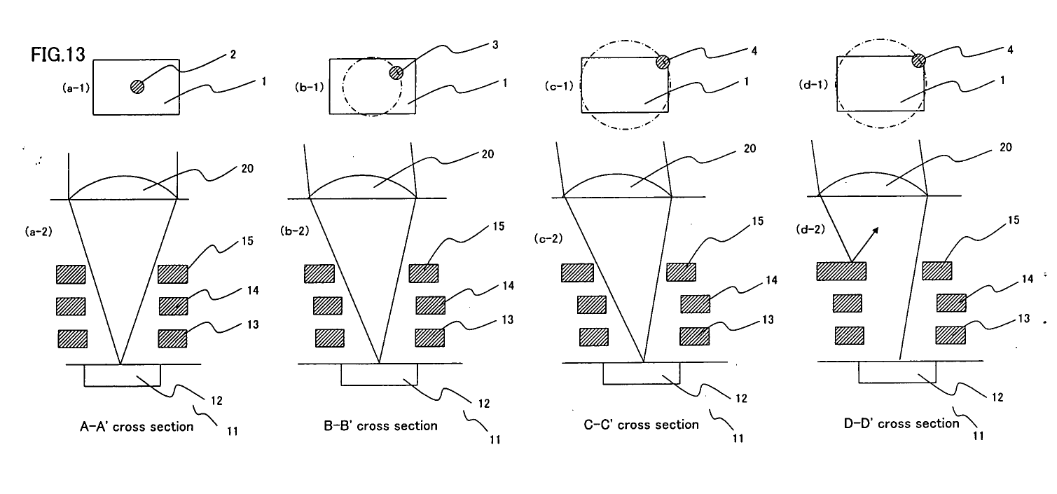

1 image capturing area
2 central portion of an image capturing area
3, 4 peripheral portion of an image capturing area
11 semiconductor substrate
12 light receiving section (unit pixel section)
13 metal wiring of a third layer
14 metal wiring of a second layer
15 metal wiring of an uppermost layer
16 via contact
20 microlens (on-chip lens)

### BEST MODE FOR CARRYING OUT THE INVENTION

Hereinafter, Embodiments 1 to 3 having a solid-state image capturing device according to the present invention applied to a CMOS image sensor will be described in detail with reference to the accompanying drawings.

### Embodiment 1-1

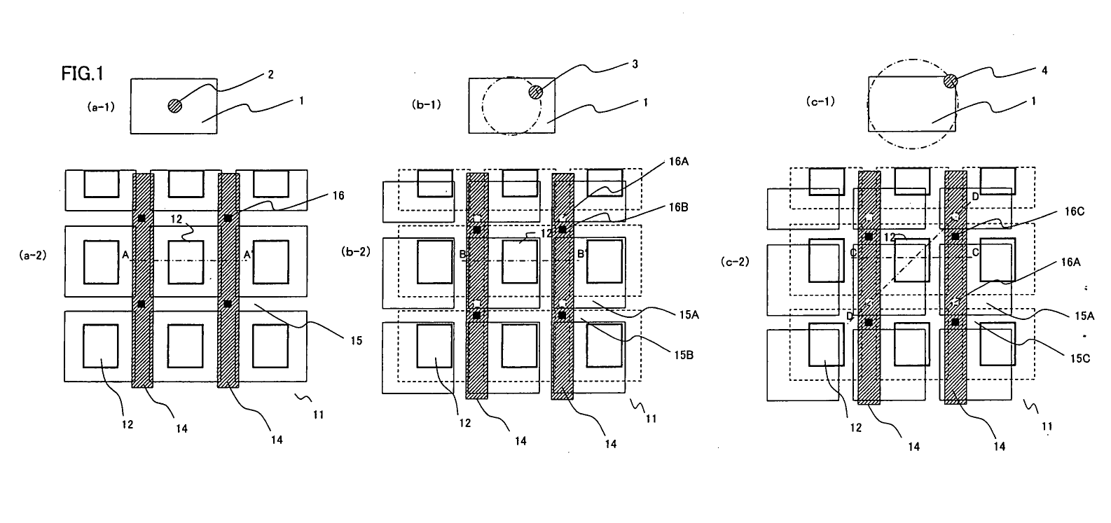

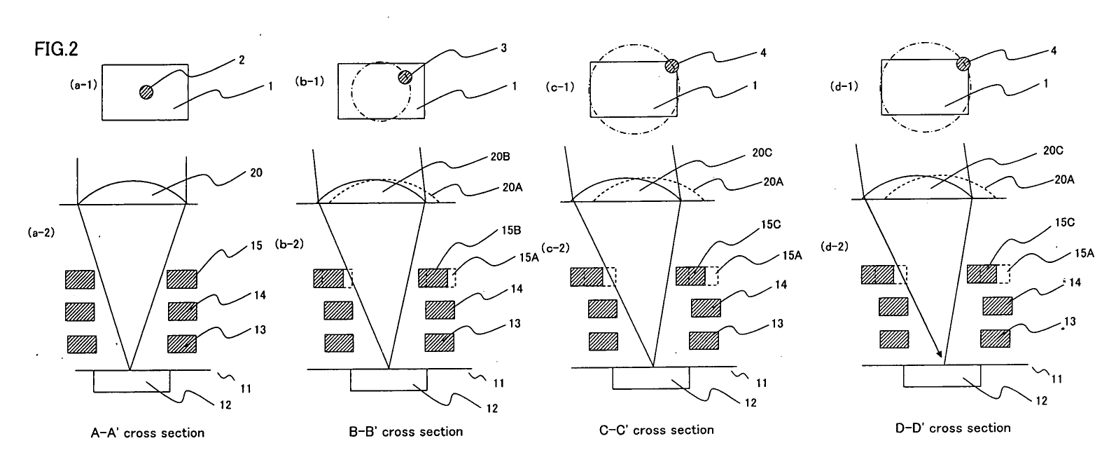

FIG. 1 is a diagram showing an exemplary essential structure of a solid-state image capturing device according to Embodiment 1-1 of the present invention. Portion (a-2) of FIG. 1 is a plan view of a unit pixel section at a central portion of an image capturing area shown in Portion (a-1) of FIG. 1. Portion (b-2) of FIG. 1 is a plan view of a unit pixel section at a middle portion between the central portion and an outermost periphery of an image capturing area shown in Portion (b-1) of FIG. 1. Portion (a-2) of FIG. 1 is a plan view of a unit pixel section at the outermost periphery of an image capturing area shown in Portion (c-1) of FIG. 1. FIG. 2 is also a diagram showing an exemplary essential structure of a solid-state image capturing device according to Embodiment 1-1 of the present invention. Portion (a-2) of FIG. 2 is a cross-sectional view of A-A′ line in Portion (a-2) of FIG. 1 of a unit pixel section at the central portion of the image capturing area 1 shown in Portion (a-1) of FIG. 2. Portion (b-2) of FIG. 2 is across-sectional view of B-B′ line in Portion (b-2) of FIG. 1 of a unit pixel section at the middle portion between the central portion and the outermost periphery of the image capturing area 1 shown in Portion (b-1) of FIG. 2. Portions (c-2) and (d-2) of FIG. 2 are cross-sectional views of C-C′ and D-D′ lines in Portion (c-2) of FIG. 1 of a unit pixel section at the outermost periphery of the image capturing area 1 shown in Portions (c-1) and (d-1) of FIG. 2, respectively.

In Portions (a-1) and (a-2) of FIG. 1 to Portions (c-1) and (c-2) of FIG. 1 and Portions (a-1) and (a-2) of FIG. 2 to Portions (d-1) and (d-2) of FIG. 2, an image capturing area 1 of the solid-state image capturing device according to Embodiment 1-1 is structured having a plurality of light receiving sections 12 provided at an upper portion of a semiconductor substrate 11 in a two-dimensional array. A plurality of layers of metal wirings 13 to 15 is provided to avoid areas above the light receiving sections 12 located at the top of the semiconductor substrate 11, and the plurality of layers of metal wirings 13 to 15 are connected to each other by way of via contacts 16 (which are via contact sections). Microlenses 20 are arranged above the metal wirings 13 to 15 in order to focus light (subject light) onto the respective light receiving sections 12.

In this solid-state image capturing device, an incident angle of light increases as an observed portion of the image capturing area 1 moves from a central portion 2 toward peripheral portions 3 and 4 of the image capturing area 1. Accordingly, in order for the light angularly incident to be focused onto the center of a light receiving section 12, a position of each microlens 20 relative to a unit pixel (light receiving section 12) is proportionally offset in a direction so as to be closer to the center of the image capturing area 1 as an observed portion of the image capturing area 1 moves from the central portion 2 toward the peripheral portions 3 and 4 of the image capturing area 1, as shown in Portions (a-2) of FIG. 2 to (d-2) of FIG. 2. In Portions (a-2) of FIG. 2 to (d-2) of FIG. 2, a dotted line 20A indicates a position of a microlens 20 prior to the offset thereof, and solid lines 20B and 20C indicate a position of a microlens 20 after the offset thereof, respectively.

In Embodiment 1-1, as shown in Portions (a-2) of FIG. 1 to (c-2) of FIG. 1, the metal wirings 15 of an uppermost layer of the metal wirings 13 to 15 are provided in a lattice pattern so as to avoid areas above the light receiving sections 12, and metal wirings 14 of a second layer connected to the metal wirings 15 by way of the via contacts 16 are arranged in a vertical direction (up-and-down direction in a plan view of FIG. 1; one direction). The via contacts 16 are positioned at wiring portions extending in a horizontal direction (left-and-right direction in the plan view in FIG. 1; direction perpendicular to the one direction) of the metal wirings 15 of the uppermost layer. In Embodiment 1-1, each via contact 16 is positioned at an intersection between the horizontal direction and the vertical direction of the metal wirings 15 of the uppermost layer.

A position of each metal wiring 15 of the uppermost layer relative to a unit pixel (light receiving section 12) is offset in a radial direction so as to be closer to the central portion 2 of the image capturing area 1 such that an offset amount, with respect to the light receiving section 12, of each metal wiring 15 of the uppermost layer increases as an observed portion of the image capturing area 1 moves from the central portion 2 toward the peripheral portions 3 and 4 of the image capturing area 1. In FIGS. 1 and 2, a dotted line 15A indicates a position of a metal wiring 15 of the uppermost layer prior to the offset thereof (position of the metal wiring 15 at the central portion 2), and solid lines 15B and 15C indicate a position of a metal wiring 15 of the upper layer after the offset thereof (position of the metal wiring 15 at each of the peripheral portions 3 and 4), respectively.

When a relative position of the metal wiring 15 of the uppermost layer does not change at the central position 2 and at the peripheral portions 3 and 4, metal wirings 15 of the uppermost layer are positioned, as shown in Portion (a-2) of FIG. 2 to Portion (d-2) of FIG. 2, at a location indicated by the dotted line 15A at the peripheral portions 3 and 4. Therefore, light hits the metal wirings 15, thereby blocking the light, which results in a reduced light receiving sensitivity of the light receiving sections 12 at the peripheral portions 3 and 4 and causes an occurrence of luminance shading.

In contrast, in Embodiment 1-1, a position of each metal wiring 15 of the uppermost layer relative to a unit pixel (light receiving section 12) is offset in a radial direction so as to be closer to the center of the image capturing area 1 as shown by the solid line 15B at the middle position (peripheral portion 3) of the image capturing area 1 shown in Portions (b-1) and (b-2) of FIG. 2; and by the solid line 15C at the outermost periphery (peripheral portion 4) of the image capturing area 1 shown in Portions (c-1) and (c-2) of FIG. 2. As a result, incident light does not hit the metal wirings 15 indicated by the solid lines 15B and 15C, thereby focusing the light onto the light receiving section 12.

Since the metal wirings 14 of the second layer and metal wirings 13 of a third layer are connected to a circuit, a position of each metal wiring 14 and each metal wiring 13 relative to a unit pixel (light receiving section 12) does not change at the central portion 2 and at the peripheral portions 3 and 4.

Further, similar to a positional offset of each metal wiring 15 of the uppermost layer relative to a unit pixel, a position of each via contact 16 relative to a unit pixel is offset in a vertical direction so as to be closer to the center of the image capturing area 1 as an observed portion of the image capturing area 1 moves toward an up direction or down direction from a horizontal line passing through the center of the image capturing area 1. In FIGS. 1 and 2, a dotted square 16A indicates a position of a via contact 16 prior to the offset thereof, and black squares 16B and 16C indicate a position of a via contact 16 after the offset thereof, respectively. An offset amount of a via contact 16 in the vertical direction matches an offset amount of a wiring 15 of the uppermost layer in the vertical direction.

As described above, according to Embodiment 1-1, a position of each metal wiring 15 of the uppermost layer relative to a unit pixel is offset at the central portion 2 and at the peripheral portions 3 and 4 of the image capturing area 1, and a position of each via contact 16 relative to a unit pixel is offset at the central portion 2 and at the peripheral portions 3 and 4 of the image capturing area 1. However, an offset amount of a via contact 16 in the vertical direction matches an offset amount of a metal wiring 15 of the uppermost layer in the vertical direction, and via contacts 16 are positioned at wiring portions extending in a horizontal direction of metal wirings 15 of the uppermost layer. Thus, the via contacts 16 are always positioned at the metal wirings 15 of the uppermost layer even if metal wirings 15 of the upper layer are offset in a horizontal direction. Accordingly, the via contacts 16 can be always connected to the metal wirings 15 of the uppermost layer.

Further, via contacts 16 are offset in the vertical direction as an observed portion of the image capturing area 1 moves from the central portion 2 toward the peripheral portions 3 and 4 of the image capturing area 1. However, the via contacts 16 are always arranged on metal wirings 14 of the second layer since the metal wirings 14 of the second layer are arranged in the vertical direction. Since the metal wirings 14 of the second layer are connected to the circuit, a solid-state image capturing device according to Embodiment 1-1 is designed such that a position of each metal wiring 14 of the second layer relative to a unit pixel does not change at the central portion 2 and at the peripheral portions 3 and 4 of the image capturing area 1. However, the metal wirings 14 of the second layer can be always connected to the via contacts 16.

With a limitation that a position of each metal wiring 14 of the second layer relative to a unit pixel cannot change at the central portion 2 and at the peripheral portions 3 and 4 of the image capturing area 1 since the metal wirings 14 of the second layer are connected to the circuit as described above, metal wirings 15 are arranged such that a position of each metal wiring 15 of the uppermost layer relative to a unit pixel is offset so as to be closer to the central portion 2 of the image capturing area 1 as an observed portion of the image capturing area 1 moves from the central portion 2 toward the peripheral portions 3 and 4 of the image capturing area 1, and the metal wirings 15 of the uppermost layer and the metal wirings 14 of the second layer can be always connected to each other by way of the via contacts 16.

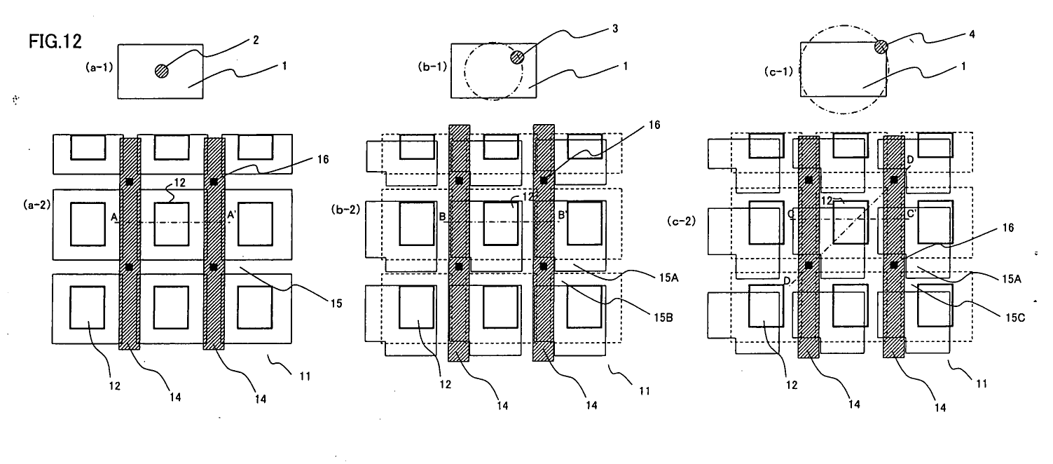

In this case, a size (wiring width) of a metal wiring 15 of the uppermost layer does not change at the central portion 2 and at the peripheral portions 3 and 4 of the image capturing area 1. Thus, the wiring width of the metal wiring 15 of the uppermost layer does not increase, which occurs in the conventional technique shown in FIG. 12 as an observed portion of the image capturing area 1 moves toward the peripheral portions 3 and 4 of the image capturing area 1. In addition, a size (wiring width) of a metal wiring 14 of the second layer does not change at the central portion 2 and at the peripheral portions 3 and 4 of the image capturing area 1. Accordingly, the metal wiring 15 of the uppermost layer and the metal wiring 14 of the second layer do not block a focusing of light, thereby realizing a solid-state image capturing device with little luminance shading.

### Embodiment 1-2

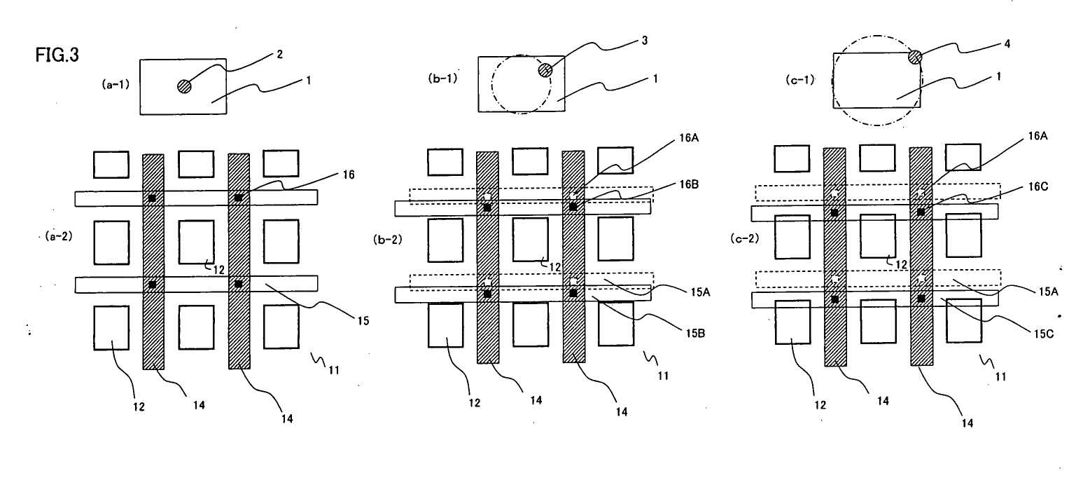

FIG. 3 is a diagram showing an exemplary essential structure of a solid-state image capturing device according to Embodiment 1-2 of the present invention. Portion (a-2) of FIG. 3 is a plan view of a unit pixel section at a central portion of an image capturing area shown in Portion (a-1) of FIG. 3. Portion (b-2) of FIG. 3 is a plan view of a unit pixel section at a middle portion between the central portion and an outermost periphery of an image capturing area shown in Portion (b-1) of FIG. 3. Portion (c-2) of FIG. 3 is a plan view of a unit pixel section at the outermost periphery of an image capturing area shown in Portion (c-1) of FIG. 3.

In Embodiment 1-2, as shown in Portions (a-1) to (a-2) of FIG. 3 to Portions (c-1) to (c-2) of FIG. 3, metal wirings 15 of an uppermost layer of a plurality of layers of metal wirings are arranged in a horizontal direction so as to avoid areas above light receiving sections 12, and metal wirings 14 of a second layer connected to the metal wirings 15 by way of via contacts 16 are arranged in a vertical direction. The via contacts 16 are positioned at wiring portions extending in a horizontal direction of the metal wirings 15 of the uppermost layer.

A position of each metal wiring 15 of the uppermost layer relative to a unit pixel (light receiving section 12) is proportionally offset in a vertical direction so as to be closer to the central portion 2 of the image capturing area 1 as an observed portion of the image capturing area 1 moves from the central portion 2 toward the peripheral portions 3 and 4 of the image capturing area 1 such that an offset amount, with respect to the light receiving section with 12, of the metal wiring 15 increases. In Portions (a-1) and (a-2) of FIG. 3 to (c-1) and (c-2) of FIG. 3, a dotted line 15A indicates a position of a metal wiring 15 of the uppermost layer prior to the offset thereof, and solid lines 15B and 15C indicate a position of a metal wiring 15 of the uppermost layer after the offset thereof, respectively.

Since the metal wirings 14 of the second layer and the metal wirings 13 of the third layer are connected to a circuit, a position of each metal wiring 14 and each metal wiring 13 relative to a unit pixel does not change at the central portion 2 and at the peripheral portions 3 and 4.

Further, similar to a positional offset of each metal wiring 15 of the uppermost layer relative to a unit pixel, a position of each via contact 16 relative to a unit pixel is offset in a vertical direction so as to be closer to the center of the image capturing area 1 as an observed portion of the image capturing area 1 moves toward an up direction or down direction from a horizontal line passing through the center of the image capturing area 1. In Portion (a-2) of FIG. 3 to Portion (c-2) of FIG. 3, a dotted square 16A indicates a position of a via contact 16 prior to the offset thereof, and black squares 16B and 16C indicate a position of a via contact 16 after the offset thereof, respectively. An offset amount of a via contact 16 in the vertical direction matches an offset amount of a metal wiring 15 of the uppermost layer in the vertical direction.

As described above, according to Embodiment 1-2, a position of each metal wiring 15 of the uppermost layer relative to a unit pixel is offset at the central portion 2 and at the peripheral portions 3 and 4 of the image capturing area 1, and a position of each via contact 16 relative to a unit pixel is offset at the central portion 2 and at the peripheral portions 3 and 4 of the image capturing area 1. However, an offset amount of a via contact 16 in the vertical direction matches an offset amount of a metal wiring 15 of the uppermost layer in the vertical direction, and via contacts 16 are positioned at wiring portions extending in a horizontal direction of metal wirings 15 of the uppermost layer. Thus, the via contacts 16 are always positioned at the metal wirings 15 of the uppermost layer even if the metal wirings 15 of the upper layer are offset in the horizontal direction. Accordingly, the via contacts 16 can be always connected to the metal wirings 15 of the uppermost layer.

Further, via contacts 16 are offset in the vertical direction as an observed portion of the image capturing area 1 are moved from the central portion 2 toward the peripheral portions 3 and 4 of the image capturing area 1. However, via contacts 16 are always arranged on metal wirings 14 of the second layer since the metal wirings 14 of the second layer are arranged in the vertical direction. Since the metal wirings 14 of the second layer are connected to the circuit, a solid-state image capturing device according to Embodiment 1-2 is designed such that a position of each metal wiring 14 of the second layer relative to a unit pixel does not change at the central portion 2 and at the peripheral portions 3 and 4 of the image capturing area 1. However, the metal wirings 14 of the second layer can be always connected to the via contacts 16.

With a limitation that a position of each metal wiring 14 of the second layer relative to a unit pixel cannot change at the central portion 2 and at the peripheral portions 3 and 4 of the image capturing area 1 since the metal wirings 14 of the second layer are connected to the circuit as described above, metal wirings 15 are arranged such that a position of each metal wiring 15 of the uppermost layer relative to a unit pixel is offset so as to be closer to the center of the image capturing area 1 as an observed portion of the image capturing area 1 moves from the central portion 2 toward the peripheral portions 3 and 4 of the image capturing area 1, and the metal wirings 15 of the uppermost layer and the metal wirings 14 of the second layer can be always connected to each other by way of the via contacts 16.

In this case, a size (wiring width) of a metal wiring 15 of the uppermost layer does not change at the central portion 2 and at the peripheral portions 3 and 4 of the image capturing area 1. Thus, the size (wiring width) of the metal wiring 15 of the uppermost layer does not increase as an observed portion of the image capturing area 1 moves from a central portion of the image capturing area toward the peripheral portions 3 and 4 of the image capturing area 1, which occurs in the conventional technique shown in FIG. 12. In addition, a size (wiring width) of a metal wiring 14 of the second layer does not change at the central portion 2 and at the peripheral portions 3 and 4 of the image capturing area 1. Accordingly, the metal wiring 15 of the uppermost layer and the metal wiring 14 of the second layer do not block a focusing of light, thereby realizing a solid-state image capturing device with little luminance shading.

### Embodiment 1-3

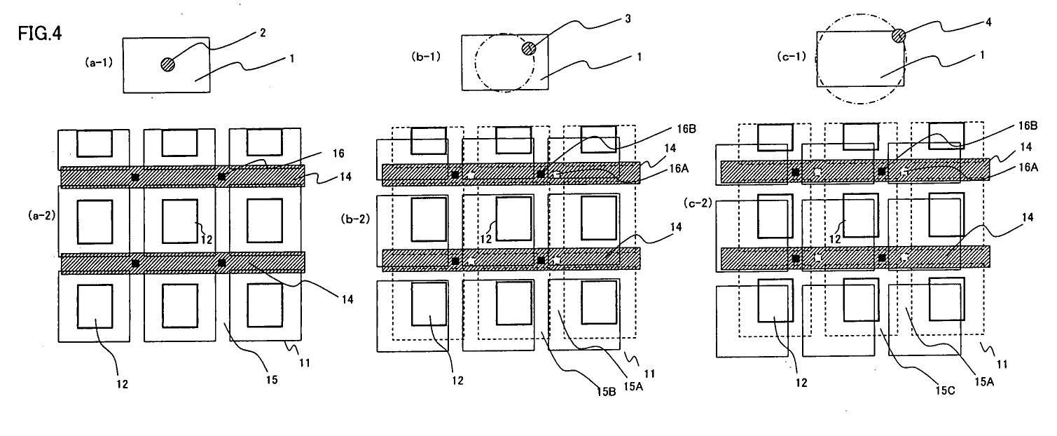

FIG. 4 is a diagram showing an exemplary essential structure of a solid-state image capturing device according to Embodiment 1-3 of the present invention. Portion (a-2) of FIG. 4 is a plan view of a unit pixel section at a central portion of an image capturing area shown in Portion (a-1) of FIG. 4. Portion (b-2) of FIG. 4 is a plan view of a unit pixel section at a middle portion between the central portion and an outermost periphery of an image capturing area shown in Portion (b-1) of FIG. 4. Portion (c-2) of FIG. 4 is a plan view of a unit pixel section at the outermost periphery of an image capturing area shown in Portion (c-1) of FIG. 4.

In Embodiment 1-3, as shown in Portions (a-1) to (a-2) of FIG. 4 to Portions (c-1) to (c-2) of FIG. 4, metal wirings 15 of an uppermost layer of a plurality of layers of metal wirings are arranged in a lattice pattern so as to avoid areas above light receiving sections 12, and metal wirings 14 of a second layer connected to the metal wirings 15 by way of via contacts 16 are arranged in a horizontal direction. The via contact 16 are positioned at wiring portions extending in a vertical direction of the metal wirings 15 of the uppermost layer. In Embodiment 1-3, each via contact 16 is positioned at an intersection between the horizontal direction and the vertical direction of the metal wirings 15 of the uppermost layer.

A position of each metal wiring 15 of the uppermost layer relative to a unit pixel (light receiving section 12) is offset in a radial direction so as to be closer to the center of the image capturing area 1 such that an offset amount, with the light receiving section with 12, of the metal wiring 15 increases as an observed portion of the image capturing area 1 moves from the central portion 2 toward the peripheral portions 3 and 4 of the image capturing area 1. In Portions (a-2) of FIG. 4 to (c-2) of FIG. 4, a dotted line 15A indicates a position of a metal wiring 15 of the uppermost layer prior to the offset thereof, and solid lines 15B and 15C indicate a position of a metal wiring 15 of the uppermost layer after the offset thereof, respectively.

Since the metal wirings 14 of the second layer and the metal wirings 13 of the third layer are connected to a circuit, a position of each metal wiring 14 and each metal wiring 13 relative to a unit pixel does not change at the central portion 2 and at the peripheral portions 3 and 4.

Further, similar to a positional offset of each metal wiring 15 of the uppermost layer relative to a unit pixel (light receiving section 12), a position of each via contact 16 relative to a unit pixel is offset in a horizontal direction so as to be closer to the center of the image capturing area 1 as an observed portion of the image capturing area 1 moves toward a left direction or right direction from a vertical line passing through the center of the image capturing area 1. In Portion (a-2) of FIG. 4 to Portion (c-2) of FIG. 4, a dotted square 16A indicates a position of a via contact 16 prior to the offset thereof, and black squares 16B and 16C indicate a position of a via contact 16 after the offset thereof, respectively. An offset amount of a via contact 16 in the horizontal direction matches an offset amount of a metal wiring 15 of the uppermost layer in the horizontal direction.

As described above, according to Embodiment 1-3, a position of each metal wiring 15 of the uppermost layer relative to a unit pixel (light receiving section 12) is offset at the central portion 2 and at the peripheral portions 3 and 4 of the image capturing area 1, and a position of each via contact 16 relative to a unit pixel is offset at the central portion 2 and at the peripheral portions 3 and 4 of the image capturing area 1. However, an offset amount of a via contact 16 in the horizontal direction matches an offset amount of a metal wiring 15 of the uppermost layer in the horizontal direction, and via contacts 16 are positioned at wiring portions extending in a vertical direction of metal wirings 15 of the uppermost layer. Thus, the via contacts 16 are always positioned at the metal wirings 15 of the uppermost layer even if the metal wirings 15 of the upper layer are offset in a vertical direction. Accordingly, the via contacts 16 can be always connected to the metal wirings 15 of the uppermost layer.

Further, via contacts 16 are offset in the horizontal direction as an observed portion of the image capturing area 1 moves from the central portion 2 toward the peripheral portions 3 and 4 of the image capturing area 1. However, the via contacts 16 are always arranged on metal wirings 14 of the second layer since the metal wirings 14 of the second layer are arranged extending in the horizontal direction. Since the metal wirings 14 of the second layer are connected to the circuit, a solid-state image capturing device according to Embodiment 1-3 is designed such that a position of each metal wiring 14 of the second layer relative to a unit pixel does not change at the central portion 2 and at the peripheral portions 3 and 4 of the image capturing area 1. However, the metal wirings 14 of the second layer can be always connected to the via contacts 16.

With a limitation that a position of each metal wiring 14 of the second layer relative to a unit pixel cannot change at the central portion 2 and at the peripheral portions 3 and 4 of the image capturing area 1 since the metal wirings 14 of the second layer are connected to the circuit as described above, metal wirings 15 are arranged such that a position of each metal wiring 15 of the uppermost layer relative to a unit pixel is offset so as to be closer to the center of the image capturing area 1 as an observed portion of the image capturing area 1 moves from the central portion 2 toward the peripheral portions 3 and 4 of the image capturing area 1, and the metal wirings 15 of the uppermost layer and the metal wirings 14 of the second layer can be connected to each other by way of the via contacts 16.

In this case, a size (wiring width) of a metal wiring 15 of the uppermost layer does not change at the central portion 2 and at the peripheral portions 3 and 4 of the image capturing area 1. Thus, the size (wiring width) of the metal wiring 15 of the uppermost layer does not increase as an observed portion of the image capturing area 1 moves from the central portion toward the peripheral portions 3 and 4 of the image capturing area 1, which occurs in the conventional technique shown in FIG. 12. In addition, a size (wiring width) of a metal wiring 14 of the second layer does not change at the central portion 2 and at the peripheral portions 3 and 4 of the image capturing area 1. Accordingly, the metal wiring 15 of the uppermost layer and the metal wiring 14 of the second layer do not block a focusing of light, thereby realizing a solid-state image capturing device with little luminance shading.

### Embodiment 1-4

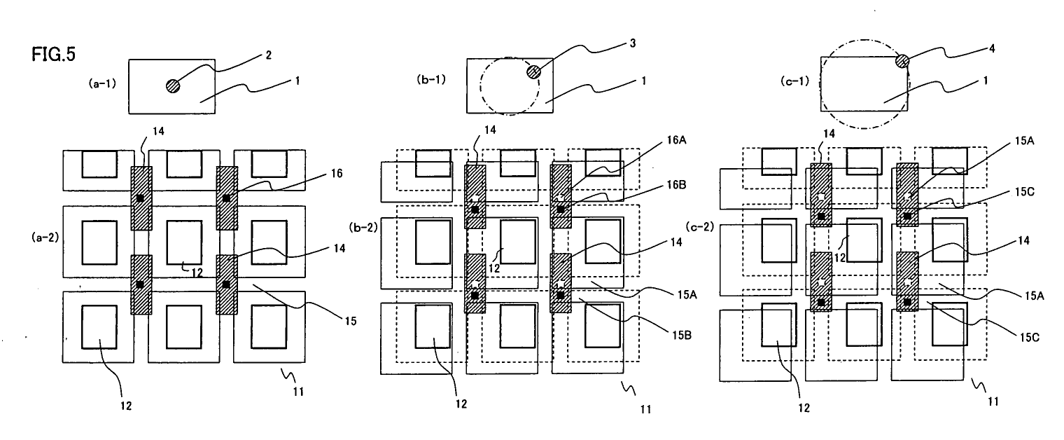

FIG. 5 is a diagram showing an exemplary essential structure of a solid-state image capturing device according to Embodiment 1-4 of the present invention; Portion (a-2) of FIG. 5 is a plan view of a unit pixel section at a central portion of an image capturing area shown in Portion (a-1) of FIG. 5; Portion (b-2) of FIG. 5 is a plan view of a unit pixel section at a middle portion between the central portion and an outermost periphery of an image capturing area shown in Portion (b-1) of FIG. 5; and Portion (c-2) of FIG. 5 is a plan view of a unit pixel section at the outermost periphery of an image capturing area shown in Portion (c-1) of FIG. 5.

In Embodiment 1-4, as shown in Portions (a-1) to (a-2) of FIG. 5 to Portions (c-1) to (c-2) of FIG. 5, metal wirings 15 of an uppermost layer of a plurality of layers of metal wirings are arranged in a lattice pattern so as to avoid areas above light receiving sections 12, and metal wirings 14 of a second layer connected to the metal wirings 15 by way of via contacts 16 are arranged in an insular strip in a vertical direction. The via contacts 16 are positioned at wiring portions extending in a horizontal direction of the metal wirings 15 of the uppermost layer. In Embodiment 1-4, each via contact 16 is positioned at an intersection between the horizontal direction and the vertical direction of the metal wirings 15 of the uppermost layer.

A position of each metal wiring 15 of the uppermost layer relative to a unit pixel (light receiving section 12) is proportionally offset in a radial direction so as to be closer to the center of the image capturing area 1 such that an offset amount, with respect to the light receiving section 12, of the metal wiring 15 increases as an observed portion of the image capturing area 1 moves from the central portion 2 toward the peripheral portions 3 and 4 of the image capturing area 1. In Portions (a-2) of FIG. 5 to (c-2) of FIG. 5, a dotted line 15A indicates a position of a metal wiring 15 of the uppermost layer prior to the offset thereof, and solid lines 15B and 15C indicate a position of a metal wiring 15 of the uppermost layer after the offset thereof, respectively.

Since the metal wirings 14 of the second layer and metal wirings 13 of a third layer (lowermost layer) are connected to a circuit, a position of each metal wiring 14 and each metal wiring 13 relative to a unit pixel does not change at the central portion 2 and at the peripheral portions 3 and 4.

Further, similar to a positional offset of each metal wiring 15 of the uppermost layer relative to a unit pixel (light receiving section 12), a position of each via contact 16 relative to a unit pixel is proportionally offset in a vertical direction so as to be closer to the center of the image capturing area 1 as an observed portion of the image capturing area 1 moves toward an up direction or down direction from a horizontal line (left-to-right direction in a plan view) passing through the center of the image capturing area 1. In Portion (a-2) of FIG. 5 to Portion (c-2) of FIG. 5, a dotted square 16A indicates a position of a via contact 16 prior to the offset thereof, and black squares 16B and 16C indicate a position of a via contact 16 after the offset thereof, respectively. An offset amount of this via contact 16 in the vertical direction matches an offset amount of a metal wiring 15 of the uppermost layer in the vertical direction. Further, a size (wiring width) of a metal wiring 14 of the second layer in the insular strip in the vertical direction is structured to be larger than an offset amount of the metal wiring 15 of the uppermost layer in the vertical direction and larger than an offset amount of the via contact 16 in the vertical direction.

As described above, according to Embodiment 1-4, a position of each metal wiring 15 of the uppermost layer relative to a unit pixel (light receiving section 12) is offset at the central portion 2 and at the peripheral portions 3 and 4 of the image capturing area 1, and a position of each via contact 16 relative to a unit pixel (light receiving section 12) is offset at the central portion 2 and at the peripheral portions 3 and 4 of the image capturing area 1. However, an offset amount of a via contact 16 in the vertical direction matches an offset amount of a metal wirings 15 of the uppermost layer in the vertical direction, and via contacts 16 are positioned at wiring portions extending in a horizontal direction of the metal wirings 15 of the uppermost layer. Thus, the via contacts 16 are always positioned at the metal wirings 15 of the uppermost layer even if the metal wirings 15 of the uppermost layer are offset in a vertical direction. Accordingly, the via contacts 16 can be always connected to the metal wirings 15 of the uppermost layer.

Further, via contacts 16 are offset in the vertical direction as an observed portion of the image capturing area 1 moves from the central portion 2 toward the peripheral portions 3 and 4 of the image capturing area 1. However, via contacts 16 are always arranged on metal wirings 14 of the second layer since the metal wirings 14 of the second layer are arranged in the insular strip in the vertical direction, and a size of a metal wiring 14 in the vertical direction is larger than an offset amount of a via contact 16 in the vertical direction. Since the metal wirings 14 of the second layer are connected to the circuit, a solid-state image capturing device according to Embodiment 1-4 is designed such that a position of each metal wiring 14 of the second layer relative to a unit pixel (light receiving section 12) does not change at the central portion 2 and at the peripheral portions 3 and 4 of the image capturing area 1. However, the metal wirings 14 of the second layer can be always connected to the via contacts 16.

With a limitation that a position of each metal wiring 14 of the second layer relative to a unit pixel (light receiving section 12) cannot change at the central portion 2 and at the peripheral portions 3 and 4 of the image capturing area 1 since the metal wirings 14 of the second layer are connected to the circuit as described above, metal wirings 15 are arranged such that a position of each metal wiring 15 of the uppermost layer relative to a unit pixel (light receiving section 12) is offset so as to be closer to the center of the image capturing area 1 as an observed portion of the image capturing area 1 moves from the central portion 2 toward the peripheral portions 3 and 4 of the image capturing area 1, and the metal wirings 15 of the uppermost layer and the metal wirings 14 of the second layer can be connected to each other by way of the via contacts 16.

In this case, a size (wiring width) of a metal wiring 15 of the uppermost layer does not change at the central portion 2 and at the peripheral portions 3 and 4 of the image capturing area 1. Thus, the size (wiring width) of the metal wiring 15 of the uppermost layer does not increase as an observed portion of the image capturing area 1 moves toward the peripheral portions 3 and 4 of the image capturing area 1, which occurs in the conventional technique shown in FIG. 12. In addition, a size (wiring width) of a metal wiring 14 of the second layer does not change at the central portion 2 and at the peripheral portions 3 and 4 of the image capturing area 1. Accordingly, the metal wiring 15 of the uppermost layer and the metal wiring 14 of the second layer do not block a focusing of light, thereby realizing a solid-state image capturing device with little luminance shading.

In Embodiments 1-1 to 1-4 described above, arrangement directions and arrangement positions for each wiring are not limited to the ones described above. However, the present invention includes all such combinations of the arrangement directions and the arrangement positions for each wiring and a switching of the vertical direction for the horizontal direction and vice-versa.

For example, in Embodiment 1-2 shown in FIG. 3, metal wirings 15 of the uppermost layer are arranged in the horizontal direction and a position of each metal wiring 15 of the uppermost layer relative to a unit pixel (light receiving section 12) is offset in the vertical direction as an observed portion of the image capturing area 1 moves from the central portion 2 toward the peripheral portions 3 and 4 of the image capturing area 1, and a position of each via contact 16 relative to a unit pixel (light receiving section 12) is also offset in the vertical direction as an observed portion of the image capturing area 1 moves from the central portion 2 toward the peripheral portions 3 and 4 of the image capturing area 1. However, the present invention is not limited to this. The present invention may be structured such that metal wirings 15 of the uppermost layer are arranged in the vertical direction (up-and-down direction) and a position of each metal wiring 15 of the uppermost layer relative to a unit pixel (light receiving section 12) is offset in the horizontal direction (left-and-right direction) as an observed portion of the image capturing area 1 moves from the central portion 2 toward the peripheral portions 3 and 4 of the image capturing area 1, and a position of each via contact 16 relative to a unit pixel (light receiving section 12) is also offset in the horizontal direction (left-and-right direction) as an observed portion of the image capturing area 1 moves from the central portion 2 toward the peripheral portions 3 and 4 of the image capturing area 1.

In this case, an offset amount of a metal wiring 15 of the uppermost layer in the horizontal direction and an offset amount of a via contact 16 in the horizontal direction match each other, and via contacts 16 are arranged on wiring portions extending in the vertical direction of metal wirings 15 of the upper layer. As a result, even if the metal wirings 15 of the uppermost layer are offset in the horizontal direction, the via contacts 16 can be always arranged on the metal wirings 15 of the uppermost layer, and the via contacts 16 can be always connected to the metal wirings 15 of the uppermost layer.

Metal wirings 14 of the second layer are arranged in the horizontal direction. As a result, even if the via contacts 16 are offset in the horizontal direction, the via contacts 16 can be always arranged on the metal wirings 14 of the second layer, and the via contacts 16 can be always connected to the metal wirings 14 of the second layer.

For example, in Embodiment 1-4 shown in FIG. 5, metal wirings 15 of the uppermost layer are arranged in the lattice pattern in the vertical direction and the horizontal direction, and a position of each metal wiring 15 of the uppermost layer relative to a unit pixel (light receiving section 12) is offset in the radial direction as an observed portion of the image capturing area 1 moves from the central portion 2 toward the peripheral portions 3 and 4 of the image capturing area 1, and a position of each via contact 16 relative to a unit pixel (light receiving section 12) is also offset in the vertical direction as an observed portion of the image capturing area 1 moves from the central portion 2 toward the peripheral portions 3 and 4 of the image capturing area 1. However, the present invention may be structured such that a position of each via contact 16 relative to a unit pixel (light receiving section 12) is offset in the horizontal direction as an observed portion of the image capturing area 1 moves from the central portion 2 toward the peripheral portions 3 and 4 of the image capturing area 1.

In this case, an offset amount of a metal wiring 15 of the uppermost layer in the horizontal direction and an offset amount of a via contact 16 in the horizontal direction match each other, and via contacts 16 are arranged on wiring portions extending in the horizontal direction of metal wirings 15 of the upper layer. As a result, even if the metal wirings 15 of the uppermost layer are offset in the horizontal direction, the via contacts 16 can be always arranged on the metal wirings 15 of the uppermost layer, and the via contacts 16 can be always connected to the metal wirings 15 of the uppermost layer.

Further, metal wirings 14 of the second layer are arranged in an insular shape in the horizontal direction, and a size of a metal wiring 14 of the second layer in the horizontal direction is larger than an offset amount of a via contact 16 in the horizontal direction. As a result, even if the via contacts 16 are offset in the horizontal direction, the via contacts 16 can be always arranged beneath the metal wirings 14 of the second layer, and the via contacts 16 can be always connected to the metal wrings 14 of the second layer.

Next, a method for manufacturing the solid-state image capturing device described in Embodiment 1 will be described.

In Embodiment 1 described above, a position of each metal wiring 15 of the uppermost layer or a position of each via contact 16 relative to a unit pixel (light receiving section 12) is offset such that an offset amount of each metal wiring 15 of the uppermost layer or an offset amount of each via contact 16 with respect to a light receiving section 12 becomes larger as an observed portion of the image capturing area 1 moves from the central portion 2 toward peripheral portions of the image capturing area 1. However, depending on a mask-making device, it is possible to offset a relative position in a radial direction and also possible to offset a relative position in a vertical direction, yet not possible to offset a relative position in a horizontal direction. On the other hand, depending on a mask-making device, it is possible to offset a relative position in a radial direction and also possible to offset a relative position in a horizontal direction, yet not possible to offset a relative position in a vertical direction.

For example, in the case when it is possible to offset a relative position in a radial direction and also possible to offset a relative position in a vertical direction, yet not possible to offset a relative position in a horizontal direction due to a mask-making device, each of the structures according to Embodiments 1-1 and 1-2 described with reference to FIGS. 1 and 3 can be realized by (i) offsetting a position of each metal wiring 15 of the uppermost layer relative to a unit pixel (light receiving section 12) in the radial direction; (ii) offsetting a position of each via contact 16 relative to a unit pixel (light receiving section 12) in the vertical direction; and (iii) by not offsetting a position of each metal wiring 14 of the second layer relative to a unit pixel (light receiving section 12).

However, the structure according to Embodiment 1-3 described with reference to FIG. 4 requires offsetting a position of each via contact 16 relative to a unit pixel (light receiving section 12) in the horizontal direction. Thus, the structure according to Embodiment 1-3 does not correspond to the case described above.

In this case, it is possible for the structure according to Embodiment 1-3 to correspond to the case described above by conducting a setup in accordance with a limitation of a mask-making device, the setup including, for example, a setting direction of the image capturing area 1, wiring directions of metal wirings 15 of the uppermost layer and metal wirings 14 of the second layer and an offsetting direction of a position relative to each unit pixel (each light receiving section 12) as an observed portion of the image capturing area 1 moves from the central portion toward the peripheral portions 3 and 4 of the image capturing area 1.

For example, when an up-and-down direction and a left-and-right direction of the image capturing area 1 are interchanged, it is possible to change an offsetting direction of each via contact 16 relative to a unit pixel (light receiving section 12) to the vertical direction, thereby realizing the structure according to Embodiment 1-3 shown in FIG. 4. In addition, when a layout of the circuit is changed, it is possible, by changing an arrangement direction of the second layer from the horizontal direction to the vertical direction, to realize the structure according to Embodiment 1-3 shown in FIG. 4.

### Embodiment 2-1

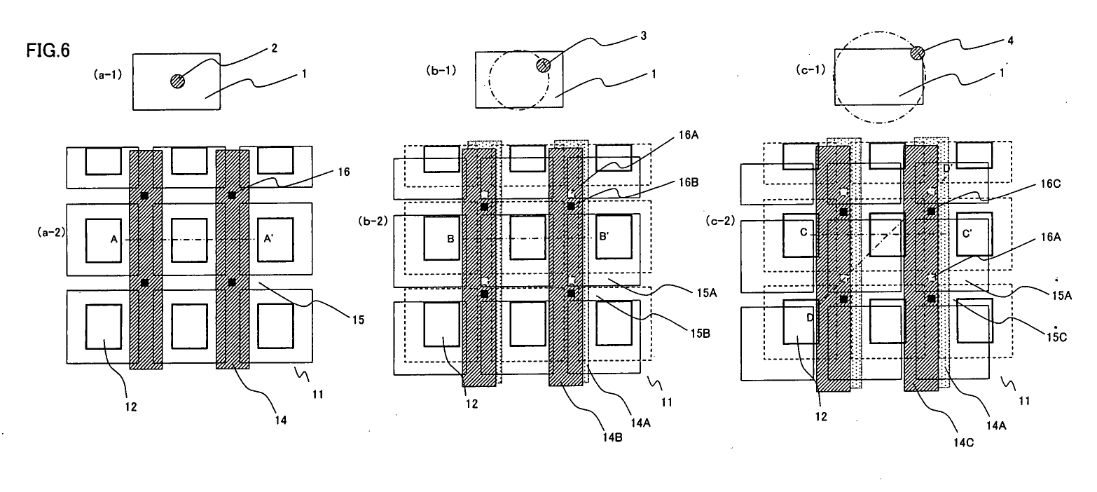

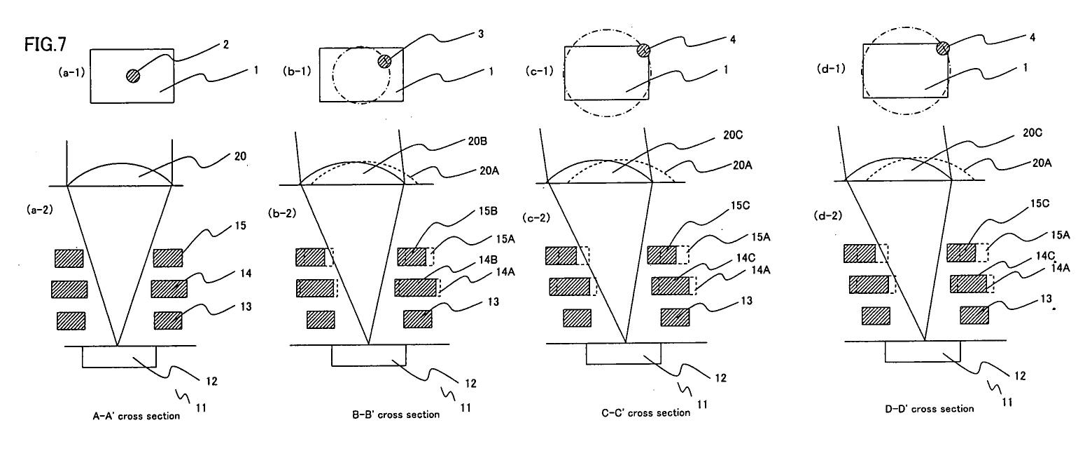

FIG. 6 is a diagram showing an exemplary essential structure of a solid-state image capturing device according to Embodiment 2-1 of the present invention. Portion (a-2) of FIG. 6 is a plan view of a unit pixel section at a central portion of an image capturing area shown in Portion (a-1) of FIG. 6. Portion (b-2) of FIG. 6 is a plan view of a unit pixel section at a middle portion between the central portion and an outermost periphery of an image capturing area shown in Portion (b-1) of FIG. 6. Portion (c-2) of FIG. 6 is a plan view of a unit pixel section at the outermost periphery of an image capturing area shown in Portion (c-1) of FIG. 6. FIG. 7 is also a diagram showing an exemplary essential structure of a solid-state image capturing device according to Embodiment 2-1 of the present invention. Portion (a-2) of FIG. 7 is a cross-sectional view of A-A′ line in Portion (a-2) of FIG. 6 of a unit pixel section at the central portion of the image capturing area shown in Portion (a-1) of FIG. 7. Portion (b-2) of FIG. 7 is across-sectional view of B-B′ line in Portion (b-2) of FIG. 6 of a unit pixel section at the middle portion between the central portion and the outermost periphery of the image capturing area shown in Portion (b-1) of FIG. 7. Portions (c-2) and (d-2) of FIG. 7 are cross-sectional views of C-C′ and D-D′ lines in Portion (c-2) of FIG. 6 of a unit pixel section at the outermost periphery of the image capturing area shown in Portions (c-1) and (d-1) of FIG. 7, respectively.

In Portions (a-1) and (a-2) of FIG. 6 to Portions (c-1) and (c-2) of FIG. 6 and Portions (a-1) and (a-2) of FIG. 7 to Portions (d-1) and (d-2) of FIG. 7, an image capturing area 1 of the solid-state image capturing device according to Embodiment 2-1 is structured, similar to Embodiment 1-1 shown in FIGS. 1 and 2, having a plurality of light receiving sections 12 provided at an upper portion of a semiconductor substrate 11 in a two-dimensional array. A plurality of layers of metal wirings 13 to 15 is provided above the semiconductor substrate 11 so as to avoid areas above the light receiving sections 12, and the plurality of layers of metal wirings 13 to 15 are connected to each other by way of via contacts 16. Microlens 20 are arranged above the metal wirings 13 to 15 in order to focus incident light onto the respective light receiving sections 12.

In order for angularly incident light (subject light) to be focused onto the center of the light receiving section 12, a position of each microlens 20 relative to a unit pixel (light receiving section 12) is offset in a direction so as to be closer to the center of the image capturing area 1 as an observed portion of the image capturing area 1 moves from the central portion 2 toward the peripheral portions 3 and 4 of the image capturing area 1, as shown in Portions (a-2) of FIG. 7 to (d-2) of FIG. 7. In Portions (a-2) of FIG. 7 to (d-2) of FIG. 7, a dotted line 20A indicates a position of a microlens 20 prior to the offset thereof, and solid lines 20B and 20C indicate a position of a microlens 20 after the offset thereof, respectively.

In Embodiment 2-1, as shown in Portions (a-2) of FIG. 6 to (c-2) of FIG. 6, the metal wirings 15 of an uppermost layer are provided in a lattice pattern so as to avoid areas above the light receiving sections 12, and the metal wirings 14 of a second layer from the top connected to the metal wirings 15 by way of the via contacts 16 are arranged in a vertical direction. The via contacts 16 are positioned at wiring portions extending in a horizontal direction of the metal wirings 15 of the uppermost layer. In Embodiment 2-1, each via contact 16 is positioned at an intersection between the horizontal direction and the vertical direction of the metal wirings 15 of the uppermost layer at the central portion 2.

A position of each metal wiring 15 of the uppermost layer relative to a unit pixel (light receiving section 12) is offset in a radial direction so as to be closer to the center of the image capturing area 1 such that an offset amount, with respect to the light receiving section 12, of each metal wiring 15 of the uppermost layer increases as an observed portion of the image capturing area 1 moves from the central portion 2 toward the peripheral portions 3 and 4 of the image capturing area 1. In FIGS. 6 and 7, a dotted line 15A indicates a position of a metal wiring 15 of the uppermost layer prior to the offset thereof, and solid lines 15B and 15C indicate a position of a metal wiring 15 of the upper layer after the offset thereof, respectively.

When a relative position of a metal wiring 15 of the uppermost layer does not change at the central position 2 and at the peripheral portions 3 and 4 of the image capturing area 1, metal wirings 15 of the uppermost layer are positioned, as shown in FIG. 7, at a location indicated by the dotted line 15A at the peripheral portions 3 and 4. Therefore, light hits the metal wirings 15, thereby blocking the light, which results in a reduced light receiving sensitivity of the light receiving sections 12 at the peripheral portions 3 and 4 and causes an occurrence of luminance shading.

In contrast, in Embodiment 2-1, a position of each metal wiring 15 of the uppermost layer relative to a unit pixel (light receiving section 12) is offset in a radial direction so as to be closer to the center of the image capturing area 1 as shown by the solid line 15B at the middle position (peripheral portion 3) of the image capturing area 1 shown in 7; and shown by the solid line 15C at the outermost periphery (peripheral portion 4) of the image capturing area 1. As a result, incident light does not hit the metal wirings 15 shown by the solid lines 15B and 15C, thereby focusing the light onto the light receiving section 12.

Further, similar to a positional offset of each metal wiring 15 of the uppermost layer relative to a unit pixel (light receiving section 12), a position of each via contact 16 relative to a unit pixel is offset in a vertical direction so as to be closer to the center of the image capturing area 1 such that an offset amount, with respect to the light receiving section 12, of each via contact 16 increases as an observed portion of the image capturing area 1 moves toward an up direction or down direction from a horizontal line passing through the center of the image capturing area 1. In FIGS. 6 and 7, a dotted square 16A indicates a position of a via contact 16 prior to the offset thereof, and black squares 16B and 16C indicate a position of a via contact 16 after the offset thereof, respectively. An offset amount of a via contact 16 in the vertical direction matches an offset amount of a metal wiring 15 of the uppermost layer in the vertical direction.

Moreover, a position of each metal wiring 14 of the second layer from the top relative to a unit pixel (light receiving section 12) is offset in a radial direction so as to be closer to the center of the image capturing area 1 such that an offset amount, with respect to the light receiving section 12, of each metal wiring 14 of the second layer increases as an observed portion of the image capturing area 1 moves from the central portion 2 toward the peripheral portions 3 and 4 of the image capturing area 1. In FIGS. 6 and 7, a dotted line 14A indicates a position of a metal wiring 14 of the second layer from the top prior to the offset thereof, and solid lines 14B and 14C indicate a position of a metal wiring 14 of the second layer after the offset thereof, respectively. A size (wiring width) of a metal wiring 14 of the second layer in the horizontal direction is at least larger than an offset amount of a metal wiring 14 of the second layer in the horizontal direction. In addition, a position in which each via contact 16 relative to a unit pixel (light receiving section 12) is offset as an observed portion of the image capturing area 1 moves from the central portion 2 toward the peripheral portions 3 and 4 of the image capturing area 1 matches a position in which each metal wiring 14 of the second layer relative to a unit pixel (light receiving section 12) is offset as an observed portion of the image capturing area 1 moves from the central portion 2 toward the peripheral portions 3 and 4 of the image capturing area 1.

Since metal wirings 13 of a third layer from the top are connected to a circuit, a position of each metal wiring 13 relative to a unit pixel (light receiving section 12) does not change at the central portion 2 and at the peripheral portions 3 and 4.

As described above, according to Embodiment 2-1, a position of each metal wiring 15 of the uppermost layer relative to a unit pixel is, similar to Embodiment 1-1, offset at the central portion 2 and at the peripheral portions 3 and 4 of the image capturing area 1, and a position of each via contact 16 relative to a unit pixel (light receiving section 12) is offset at the central portion 2 and at the peripheral portions 3 and 4 of the image capturing area 1. However, an offset amount of a via contact 16 in the vertical direction matches an offset amount of a metal wiring 15 of the uppermost layer in the vertical direction, and via contacts 16 are positioned at wiring portions extending in a horizontal direction of metal wirings 15 of the uppermost layer. Thus, the via contacts 16 are always positioned at the metal wirings 15 of the uppermost layer even if the metal wirings 15 of the upper layer are offset in the horizontal direction. Accordingly, the via contacts 16 can be always connected to the metal wirings 15 of the uppermost layer.

Further, in Embodiment 2-1, a position of each metal wiring 14 of the second layer from the top relative to a unit pixel (light receiving section 12) is offset at the central portion 2 and at the peripheral portions 3 and 4 of the image capturing area 1, and a position of each via contact 16 relative to a unit pixel (light receiving section 12) is offset at the central portion 2 and at the peripheral portions 3 and 4 of the image capturing area 1. However, via contacts 16 are offset in the vertical direction as an observed portion of the image capturing area 1 moves from the central portion 2 toward the peripheral portions 3 and 4 of the image capturing area 1, and an offset amount of a metal wiring 14 of the second layer in the horizontal direction arranged in the vertical direction is smaller than a size of the metal wiring 14 of the second layer in the horizontal direction. Therefore, via contacts 16 can be arranged on wiring portions of metal wirings 14 of the second layer. By setting a wiring width of the metal wirings 14 of the second layer larger, it is possible to connect the via contacts 16 to the metal wirings 14 at the central portion 2 and the peripheral portions 3 and 4, without changing the wiring width of the metal wirings 14 of the second layer for the via contacts 16.

A position of each metal wiring 14 of the second layer relative to a pixel unit (light receiving section 12) is offset in a direction so as to be closer to the center of the image capturing area 1 as an observed portion of the image capturing area 1 moves from the central portion 2 toward the peripheral portions 3 and 4 of the image capturing area 1. Therefore, it is possible to reduce the amount of incident light being blocked by a metal wiring 14 of the second layer and also possible to suppress diffused reflection of the light, thereby realizing a solid-state image capturing device with an excellent luminance shading characteristic.

### Embodiment 2-2

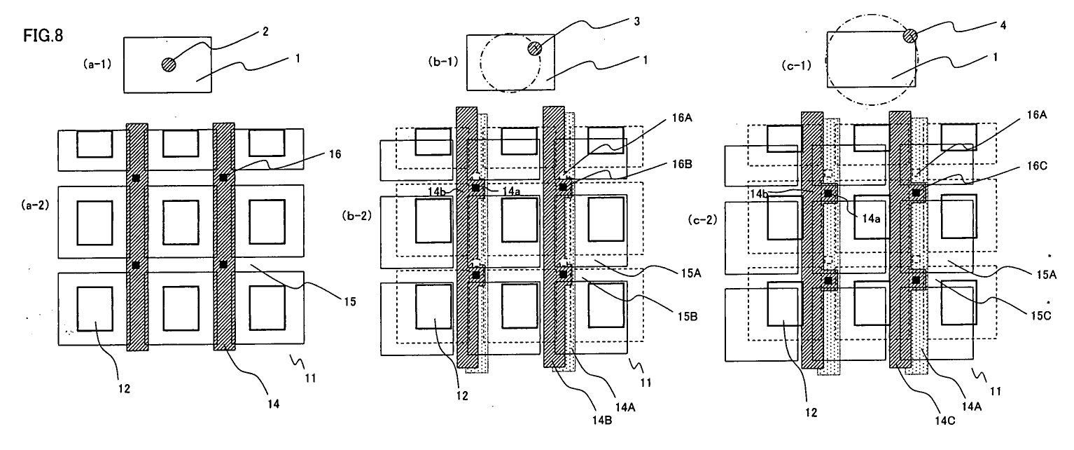

FIG. 8 is a diagram showing an exemplary important-part structure of a solid-state image capturing device according to Embodiment 2-2 of the present invention. Portion (a-2) of FIG. 8 is a plan view of a unit pixel section at a central portion of an image capturing area shown in Portion (a-1) of FIG. 8. Portion (b-2) of FIG. 8 is a plan view of a unit pixel section at a middle portion between the central portion and an outermost periphery of an image capturing area shown in Portion (b-1) of FIG. 8. Portion (c-2) of FIG. 8 is a plan view of a unit pixel section at the outermost periphery of an image capturing area shown in Portion (c-1) of FIG. 8.

In Embodiment 2-2, as shown in Portions (a-2) to (c-2) of FIG. 8, metal wirings 15 of an uppermost layer of a plurality of layers of metal wirings are arranged in a lattice pattern so as to avoid areas above light receiving sections 12, and metal wirings 14 of a second layer connected to the metal wirings 15 by way of via contacts 16 are arranged in a vertical direction. The via contacts 16 are positioned at wiring portions extending in a horizontal direction of the metal wirings 15 of the uppermost layer. In Embodiment 2-2, each via contact 16 is positioned at an intersection between the horizontal direction and the vertical direction of the metal wirings 15 of the uppermost layer of the central portion 2.

A position of each metal wiring 15 of the uppermost layer relative to a unit pixel (light receiving section 12) is offset in a radial direction so as to be closer to the center of the image capturing area 1 as an observed portion of the image capturing area 1 moves from the central portion 2 toward the peripheral portions 3 and 4 of the image capturing area 1. In FIG. 8, a dotted line 15A indicates a position of a metal wiring 15 of the uppermost layer prior to the offset thereof, and solid lines 15B and 15C indicate a position of a metal wiring 15 of the uppermost layer after the offset thereof, respectively.

Further, similar to a positional offset of each metal wiring 15 of the uppermost layer relative to a unit pixel (light receiving section 12), a position of each via contact 16 relative to a unit pixel (light receiving section 12) is offset in a vertical direction so as to be closer to the center of the image capturing area 1 as an observed portion of the image capturing area 1 moves toward an up direction or down direction from a horizontal line passing through the center of the image capturing area 1. In FIG. 8, a dotted square 16A indicates a position of a via contact 16 prior to the offset thereof, and black squares 16B and 16C indicate a position of a via contact 16 after the offset thereof, respectively. An offset amount of a via contact 16 in the vertical direction matches an offset amount of a metal wiring 15 of the uppermost layer in the vertical direction.

Moreover, the metal wiring 14 of the second layer from the top includes: portions 14a, a position of each of which relative to a unit pixel (light receiving section 12) is offset in a vertical direction as an observed portion of the image capturing area 1 moves from the central portion toward the peripheral portions 3 and 4 of the image capturing area 1; and portions 14b, a position of each of which relative to a unit pixel (light receiving section 12) is offset in a horizontal direction as an observed portion of the image capturing area 1 moves from the central portion toward the peripheral portions 3 and 4 of the image capturing area 1. The portions 14a and the respective portions 14b are connected to each other in an integrated manner. In FIG. 8, a dotted line 14A indicates a position of a metal wiring 14 of the second layer prior to the offset thereof, and solid lines 14B and 14C indicate a position of a metal wiring 14 of the second layer after the offset thereof, respectively.

In Embodiment 2-2, just a required amount of area in order to connect with a via contact 16 is provided with the portion 14a of the metal wiring 14 of the second layer offset in the vertical direction. Thus, the amount of area may be small, thereby less likely to block a focusing of light. In addition, a portion 14b of the metal wiring 14 of the second layer offset in the horizontal direction is offset in a direction such that a position of each portion 14b relative to a unit pixel (light receiving section 12) is offset so as to be closer to the center of the image capturing area 1 as an observed portion of the image capturing area 1 moves from the central portion 2 toward the peripheral portions 3 and 4 of the image capturing area 1. Therefore, it is possible to reduce the amount of incident light being blocked by a metal wiring 14 of the second layer and also possible to suppress diffused reflection of the light, thereby realizing a solid-state image capturing device with an excellent luminance shading characteristic.

In Embodiment 2-2, when there are portions in which metal wirings 13 of a third layer from the top and metal wirings 14 of a second layer from the top are connected to each other by way of other via contacts 16, by providing in the metal wiring 14 of the second layer with portions, a position of each of which relative to a unit pixel (light receiving section 12) does not change, then it is possible to connect with the metal wirings 13 of the third layer by way of the other via contacts 16. In this case, the metal wiring 14 of the second layer includes the following three portions: portions, a position of each of which relative to a unit pixel (light receiving section 12) is offset in a vertical direction as an observed portion of the image capturing area 1 moves from the central portion 2 toward the peripheral portions 3 and 4 of the image capturing area 1; portions, a position of each of which relative to a unit pixel (light receiving section 12) is offset in a horizontal direction as an observed portion of the image capturing area 1 moves from the central portion 2 toward the peripheral portions 3 and 4 of the image capturing area 1; and portions, a position of each of which relative to a unit pixel (light receiving section 12) does not change at the central portion 2 and at the peripheral portions 3 and 4 of the image capturing area 1.

### Embodiment 2-3

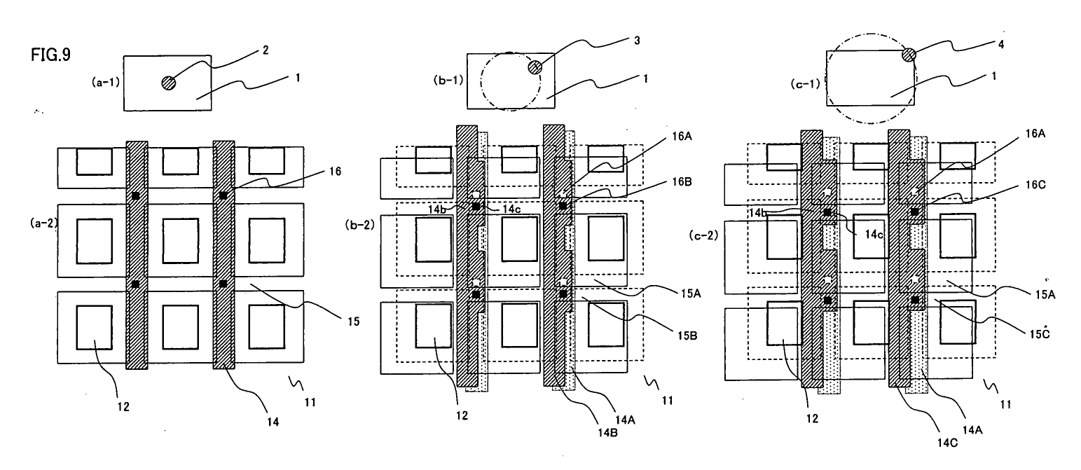

FIG. 9 is a diagram showing an exemplary essential structure of a solid-state image capturing device according to Embodiment 2-3 of the present invention. Portion (a-2) of FIG. 9 is a plan view of a unit pixel section at a central portion of an image capturing area shown in Portion (a-1) of FIG. 9. Portion (b-2) of FIG. 9 is a plan view of a unit pixel section at a middle portion between the central portion and an outermost periphery of an image capturing area shown in Portion (b-1) of FIG. 9. Portion (c-2) of FIG. 9 is a plan view of a unit pixel section at the outermost periphery of an image capturing area shown in Portion (c-1) of FIG. 9.

In Embodiment 2-3, as shown in Portions (a-2) to (c-2) of FIG. 9, metal wirings 15 of an uppermost layer of a plurality of layers of metal wirings are arranged in a lattice pattern so as to avoid areas above light receiving sections 12, and metal wirings 14 of a second layer connected to the metal wirings 15 by way of via contacts 16 are arranged in a vertical direction. The via contacts 16 are positioned at wiring portions extending in a horizontal direction of the metal wirings 15 of the uppermost layer. In Embodiment 2-3, each via contact 16 is positioned at an intersection between the horizontal direction and the vertical direction of the metal wirings 15 of the uppermost layer of the central portion.

A position of each metal wiring 15 of the uppermost layer relative to a unit pixel (light receiving section 12) is offset in a radial direction so as to be closer to the center of the image capturing area 1 such that an offset amount, with the light receiving section with 12, of the metal wiring 15 increases as an observed portion of the image capturing area 1 moves from the central portion 2 toward the peripheral portions 3 and 4 of the image capturing area 1. In FIG. 9, a dotted line 15A indicates a position of a metal wiring 15 of the uppermost layer prior to the offset thereof, and solid lines 15B and 15C indicate a position of a metal wiring 15 of the uppermost layer after the offset thereof, respectively.

Further, similar to a positional offset of each metal wiring 15 of the uppermost layer relative to a unit pixel (light receiving section 12), a position of each via contact 16 relative to a unit pixel (light receiving section) is offset in a vertical direction so as to be closer to the center of the image capturing area 1 such that an offset amount, with respect to the light receiving section 12, of each via contact 16 increases as an observed portion of the image capturing area 1 moves toward an up direction or down direction from a horizontal line passing through the center of the image capturing area 1. In FIG. 9, a dotted square 16A indicates a position of a via contact 16 prior to the offset thereof, and black squares 16B and 16C indicate a position of a via contact 16 after the offset thereof, respectively. An offset amount of a via contact 16 in the vertical direction matches an offset amount of a metal wiring 15 of the uppermost layer in the vertical direction.

Moreover, a metal wiring 14 of the second layer includes: portions 14b, a position of each of which relative to a unit pixel (light receiving section 12) is offset in a horizontal direction as an observed portion of the image capturing area 1 moves from the central portion toward the peripheral portions 3 and 4 of the image capturing area 1; and portions 14c, a position of each of which relative to a unit pixel (light receiving section 12) does not change at the central portion 2 and at the peripheral portions 3 and 4 of the image capturing area 1. The portions 14b and the respective portions 14c are connected to each other in an integrated manner. In FIG. 9, a dotted line 14A indicates a position of a metal wiring 14 of the second layer prior to the offset thereof, and solid lines 14B and 14C indicate a position of a metal wiring 14 of the second layer after the offset thereof, respectively. The portion 14c of the metal wiring 14 of the second layer in which a position of each portion 14c relative to a unit pixel (light receiving section 12) does not change at the central portion 2 and at the peripheral portions 3 and 4 of the image capturing area 1 is provided in order to connect with the via contact 16. Accordingly, a size (wiring width) of a portion 14c in the vertical direction is set larger than an offset amount of a via contact 16 (e.g., including 16A) in the vertical direction.

In Embodiment 2-2, a portion 14c of the metal wiring 14 of the second layer in which a position of each portion 14c relative to a unit pixel (light receiving section 12) does not change is provided to connect with a via contact 16. Thus, the amount of area to connect with the via contact 16 may be small, thereby less likely to block a focusing of light. In addition, a portion 14b of the metal wiring 14 of the second layer offset in the horizontal direction is offset in a direction such that each position of each portion 14b relative to a unit pixel (light receiving section 12) is offset in a direction so as to be closer to the center of the image capturing area 1 as an observed portion of the image capturing area 1 moves from the central portion 2 toward the peripheral portions 3 and 4 of the image capturing area. Therefore, it is possible to reduce the amount of incident light being blocked by a metal wiring 14 of the second layer and also possible to suppress diffused reflection of the light, thereby realizing a solid-state image capturing device with an excellent luminance shading characteristic.

In Embodiment 2-3, when there are portions in which metal wirings 13 of a third layer and metal wirings 14 of a second layer are connected to by way of other via contacts 16, by providing the metal wiring 14 of the second layer with portions, a position of each of which relative to a unit pixel (light receiving section 12) does not change, then it is possible to connect with the metal wirings 13 of the third layer by way of the other via contacts 16. In this case, the metal wiring 14 of the second layer includes the following two portions: portions, a position of each of which relative to a unit pixel (light receiving section 12) is offset in the horizontal direction as an observed portion of the image capturing area 1 moves from the central portion 2 toward the peripheral portions 3 and 4 of the image capturing area 1; and portions, a position of each of which relative to a unit pixel (light receiving section 12) does not change at the central portion 2 and at the peripheral portions 3 and 4 of the image capturing area 1.

In Embodiments 2-1 to 2-3 described above, arrangement directions and arrangement positions for each wiring are not limited to the ones described above. The present invention includes all such combinations of the arrangement directions and the arrangement positions for each wiring and a switching of the vertical direction for the horizontal direction and vice-versa.

For example, in Embodiment 2-1 shown in FIG. 6, metal wirings 14 of the second layer are arranged in the vertical direction, and a position of each metal wiring 14 of the second layer relative to a unit pixel (light receiving section 12) is offset in the radial direction as an observed portion of the image capturing area 1 moves from the central portion 2 toward the peripheral portions 3 and 4 of the image capturing area 1, and a position of each via contact 16 relative to a unit pixel (light receiving section 12) is also offset in the vertical direction as an observed portion of the image capturing area 1 moves from the central portion 2 toward the peripheral portions 3 and 4 of the image capturing area 1. However, the present invention is not limited to this. The present invention may be structured such that metal wirings 14 of the second layer are arranged in a horizontal direction and a position of each metal wiring 14 of the second layer relative to a unit pixel (light receiving section 12) is offset in a radial direction as an observed portion of the image capturing area 1 moves from the central portion 2 toward the peripheral portions 3 and 4 of the image capturing area 1, and a position of each via contact 16 relative to a unit pixel (light receiving section 12) is also offset in the horizontal direction as an observed portion of the image capturing area 1 moves from the central portion 2 toward the peripheral portions 3 and 4 of the image capturing area 1.

In this case, an offset amount of a metal wiring 14 of the second layer in the horizontal direction and an offset amount of a via contact 16 in the horizontal direction match each other, and a size (wiring width) of a metal wiring 14 of the second layer in the vertical direction is at least larger than an offset amount of the metal wiring 14 of the second layer. As a result, even if the metal wirings 14 of the second layer are offset, the via contacts 16 can be always arranged on the metal wirings 14 of the second layer, and the metal wirings 14 and the metal wirings 15 can be always connected to each other.

For example, in Embodiment 2-2 shown in FIG. 8, a position of each via contact 16 relative to a unit pixel (light receiving section 12) is also offset in the vertical direction as an observed portion of the image capturing area 1 moves from the central portion 2 toward the peripheral portions 3 and 4 of the image capturing area 1. However, the present invention may be structured such that a position of each via contact 16 relative to a unit pixel (light receiving section 12) is offset in the horizontal direction as an observed portion of the image capturing area 1 moves from the central portion 2 toward the peripheral portions 3 and 4 of the image capturing area 1.

In this case, a metal wiring 14 of the second layer is provided in the horizontal direction. The metal wiring 14 of the second layer includes: portions, a position of each of which relative to a unit pixel (light receiving section 12) is offset in the vertical direction as an observed portion of the image capturing area 1 moves from the central portion toward the peripheral portions 3 and 4 of the image capturing area 1; and portions, a position of each of which relative to a unit pixel (light receiving section 12) is offset in the horizontal direction as an observed portion of the image capturing area 1 moves from the central portion toward the peripheral portions 3 and 4 of the image capturing area 1. As a result, the portions of the metal wiring 14 of the second layer, which are offset in the horizontal direction, can be connected to the via contacts 16.

For example, in Embodiment 2-3 shown in FIG. 9, a position of each via contact 16 relative to a unit pixel (light receiving section 12) is offset in the vertical direction as an observed portion of the image capturing area 1 moves from the central portion 2 toward the peripheral portions 3 and 4 of the image capturing area 1. However, the present invention may be structured such that a position of each via contact 16 relative to a unit pixel (light receiving section 12) is offset in the horizontal direction as an observed portion of the image capturing area 1 moves from the central portion 2 toward the peripheral portions 3 and 4 of the image capturing area 1.

In this case, the metal wirings 14 of the second layer are arranged in the horizontal direction. A metal wiring 14 of the second layer includes: portions, a position of each of which relative to a unit pixel (light receiving section 12) is offset in the horizontal direction as an observed portion of the image capturing area 1 moves from the central portion 2 toward the peripheral portions 3 and 4 of the image capturing area 1; and portions, a position of each of which relative to a unit pixel (light receiving section 12) does not change at the central portion 2 and at the peripheral portions 3 and 4 of the image capturing area 1. In the portions of each metal wiring 14 of the second layer in which a position of each portion relative to a unit pixel (light receiving section 12) does not change, a size of a via contact 16 in the vertical direction is larger than an offset amount of the via contact 16 in the vertical direction. As a result, the portions of each metal wiring 14 of the second layer in which a position of each portion relative to a unit pixel does not change can be connected to the via contact 16.

### Embodiment 3

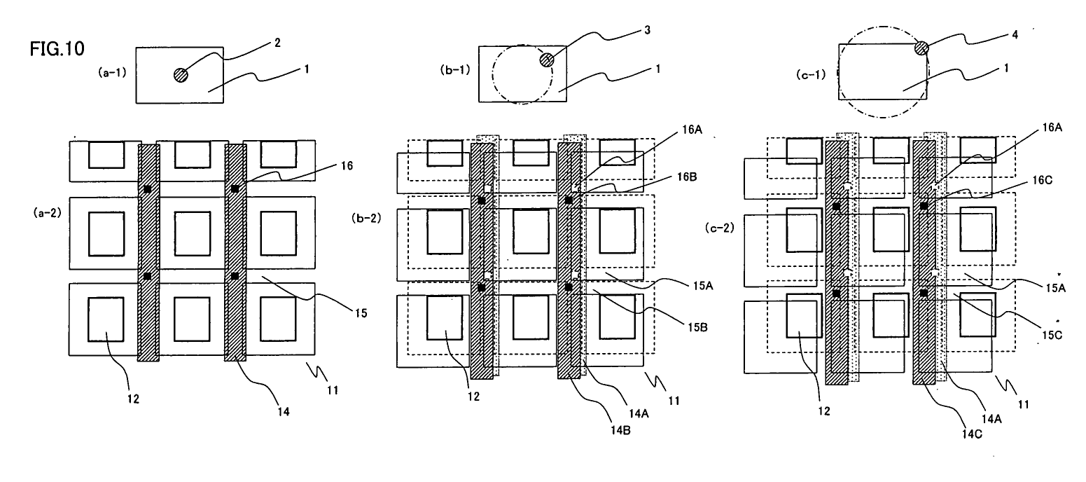

FIG. 10 is a diagram showing an exemplary essential structure of a solid-state image capturing device according to Embodiment 3 of the present invention. Portion (a-2) of FIG. 10 is a plan view of a unit pixel section at a central portion of an image capturing area shown in Portion (a-1) of FIG. 10. Portion (b-2) of FIG. 10 is a plan view of a unit pixel section at a middle portion between the central portion and an outermost periphery of an image capturing area shown in Portion (b-1) of FIG. 10. Portion (c-2) of FIG. 10 is a plan view of a unit pixel section at the outermost periphery of an image capturing area shown in Portion (c-1) of FIG. 10.

In Embodiment 3, as shown in Portions (a-2) to Portion (c-2) of FIG. 10, metal wirings 15 of an uppermost layer are provided in a lattice pattern so as to avoid areas above the light receiving sections 12, and metal wirings 14 of a second layer connected to the metal wirings 15 by way of the via contacts 16 are arranged in a vertical direction. The via contacts 16 are positioned at wiring portions extending in a horizontal direction of the metal wirings 15 of the uppermost layer. In Embodiment 3, each via contact 16 is positioned at an intersection between the horizontal direction and the vertical direction of the metal wirings 15 of the uppermost layer at the central portion.

A position of each metal wiring 15 of the uppermost layer relative to a unit pixel (light receiving section 12) is offset in a radial direction so as to be closer to the center of the image capturing area 1 as an observed portion of the image capturing area 1 moves from the central portion 2 toward the peripheral portions 3 and 4 of the image capturing area 1. In FIG. 10, a dotted line 15A indicates a position of a metal wiring 15 of the uppermost layer prior to the offset thereof, and solid lines 15B and 15C indicate a position of a metal wiring 15 of the upper layer after the offset thereof, respectively.

Further, similar to a positional offset of each metal wiring 15 of the uppermost layer relative to a unit pixel (light receiving section), a position of each via contact 16 relative to a unit pixel is offset in a radial direction so as to be closer to the center of the image capturing area 1 as an observed portion of the image capturing area 1 moves from the central portion 2 toward the peripheral portions 3 and 4 of the image capturing area 1. In FIG. 10, a dotted square 16A indicates a position of a via contact 16 prior to the offset thereof, and black squares 16B and 16C indicate a position of a via contact 16 after the offset thereof, respectively. An offset amount of a via contact 16 in the vertical direction matches an offset amount of a metal wiring 15 of the uppermost layer in the vertical direction.

Further, a position of each metal wiring 14 of the second layer relative to a unit pixel (light receiving section 12) is offset in a radial direction so as to be closer to the center of the image capturing area 1 as an observed portion of the image capturing area 1 moves from the central portion 2 toward the peripheral portions 3 and 4 of the image capturing area 1. In FIG. 10, a dotted line 14A indicates a position of a metal wiring 14 of the second layer prior to the offset thereof, and solid lines 14B and 14C indicate a position of a metal wiring 14 of the second layer after the offset thereof, respectively. An offset amount of a via contact 16 in the horizontal direction matches an offset amount of a metal wiring 14 of the second layer in the horizontal direction.

As described above, according to Embodiment 3, a position of each metal wiring 15 of the uppermost layer relative to a unit pixel (light receiving section 12) is offset at the central portion 2 and at the peripheral portions 3 and 4 of the image capturing area 1, and a position of each via contact 16 relative to a unit pixel (light receiving section 12) is also offset at the central portion 2 and at the peripheral portions 3 and 4 of the image capturing area 1. However, an offset amount of a via contact 16 in the vertical direction matches an offset amount of a metal wiring 15 of the uppermost layer in the vertical direction. Thus, the via contacts 16 can be always connected to the metal wirings 15 of the uppermost layer. In addition, a position of each metal wiring 14 of the second layer relative to a unit pixel (light receiving section 12) is offset at the central portion 2 and at the peripheral portions 3 and 4 of the image capturing area 1, and a position of each via contact 16 relative to a unit pixel (light receiving section 12) is also offset at the central portion 2 and at the peripheral portions 3 and 4 of the image capturing area 1. However, an offset amount of a via contact 16 in the horizontal direction matches an offset amount of a metal wiring 14 of the second layer. Thus, the via contacts 16 can be always connected to the metal wirings 14 of the second layer. A position of each metal wiring 15 of the uppermost layer and each metal wiring 14 of the second layer relative to a pixel unit (light receiving section 12) is offset in a direction so as to be closer to the central portion 2 of the image capturing area 1 as an observed portion of the image capturing area 1 moves from the central portion toward the peripheral portions 3 and 4 of the image capturing area 1. Therefore, it is possible to reduce the amount of incident light being blocked by a metal wiring 15 of the uppermost layer and a metal wiring 14 of the second layer and also possible to suppress diffused reflection of the light, thereby realizing a solid-state image capturing device with an excellent luminance shading characteristic.

In Embodiment 3 described above, arrangement directions and arrangement positions for each wiring are not limited to the ones described above. The present invention includes all such combinations of the arrangement directions and the arrangement positions for each wiring and a switching of the vertical direction for the horizontal direction and vice-versa.

For example, in Embodiment 3 shown in FIG. 10, metal wirings 14 of the second layer are arranged in the vertical direction. However, the metal wiring 14 of the second layer can be arranged in the horizontal direction.

In this case, an offset amount of a via contact 16 in the horizontal direction and an offset amount of a metal wiring 15 of the uppermost layer in the horizontal direction match each other, and an offset amount of a via contact 16 in the horizontal direction and an offset amount of a metal wiring 14 of the second layer in the vertical direction match each other. As a result, even if the metal wirings 15 of the uppermost layer and the metal wirings 14 of the second layer are offset, the via contacts 16 can be always connected to the metal wirings 15 of the uppermost layer and the metal wirings 14 of the second layer.

In Embodiments 1 to 3, the description has been given regarding the metal wiring 15 of the uppermost layer, the metal wiring 14 of the second layer and the via contact 16 for connecting the metal wiring 15 and the metal wiring 14 to each other. However, the present invention is not limited to this. The present invention can be applied to all the layers of metal wirings and via contacts 16 for connecting the layers of metal wirings to each other. In addition, the layers of metal wirings 14 and 15 and the via contact 16 are not limited to the ones described in Embodiments 1 to 3. The metal wirings 14 and 15 of layers and the via contact 16 can be changed as appropriate as long as they are electrically connected to each other.

Further, in Embodiments 1 to 3, a position of each microlens 20, each of the metal wirings 13 to 15 and each via contact 16 relative to a unit pixel (light receiving section 12) is offset in a direction so as to be closer to the center of the image capturing area 1 as an observed portion of the image capturing area 1 moves from the central portion 2 toward the peripheral portions 3 and 4 of the image capturing area 1. However, a position of each microlens 20, each of the metal wirings 13 to 15 and each via contact 16 relative to a unit pixel (light receiving section 12) can be offset in a direction so as to be farther from the center of the image capturing area 1 as an observed portion of the image capturing area 1 moves from the central portion 2 toward the peripheral portions 3 and 4 of the image capturing area 1. Moreover, the present invention can be applied not only to the case where a position relative to each unit pixel (each light receiving section 12) is monotonously offset, but also to a case where an offset amount changes midway.

Further, Embodiments 1 to 3, the description has bee given regarding the horizontal direction and the vertical direction. However, the present invention can be applied to a case where offsetting directions of a position relative to each unit pixel in the image capturing area 1 does not are in the horizontal direction and the vertical direction of the image capturing area 1 as long as offsetting directions of a position relative to each unit pixel in the image capturing area 1 are perpendicular to each other.

In summary, in Embodiments 1 to 3, a description has not specifically given. However, in a solid-state image capturing device according to the present invention, only an offset amount of a position of at least wirings of an upper layer of a plurality of layers of wirings has to increase as an observed portion of the image capturing area 1 moves from the central portion 2 toward peripheral portions 3 and 4 of the image capturing area 1 such that the plurality of layer of wirings are arranged so as not to block incident light onto respective light receiving sections 12, and only an offset amount of a position of via contacts 16 connected to the respective wirings of the upper layer has to increase as an observed portion of the image capturing area 1 moves from the central portion 2 toward peripheral portions 3 and 4 of the image capturing area 1 such that the via contacts 16 are arranged so as not to block incident light onto the light receiving sections 12. Accordingly, it is possible to prevent “kerare (vignetting)” by the plurality of layers of wirings at the peripheral portions 3 and 4 of the image capturing area 1 and possible to suppress a reduction of a light receiving sensitivity. As a result, the objective of the present invention of obtaining a solid-state image capturing device with an excellent luminance shading characteristic can be achieved.

In Embodiments 1 to 3, any description has not specifically given. Herein, a description will be given regarding an electronic information device having, for example, a digital camera (e.g., digital video camera, digital still camera, digital movie camera), an image input camera (e.g., vehicle-mounted camera, monitoring camera, door-phone camera and camera for television telephone) and an image input device (e.g., scanner, facsimile and cell phone telephone device with camera) using a solid-state image capturing device according to Embodiments 1 to 3 for an image capturing section thereof. Especially, the electronic information device according to the present invention is important in a camera module using a CMOS imager. The electronic information device according to the present invention includes at least one of: a memory section (e.g., recording media) for data-recording a high-quality image data obtained by using the solid-state image capturing device according to Embodiments 1 to 3 of the present invention for the image capturing section after a predetermined signal process is performed on the image dada for recording; display means (e.g., liquid crystal display device) for displaying this image data on a display screen (e.g., liquid crystal display screen) after a predetermined signal process is performed on the image data for display; communication means (e.g., transmitting and receiving device) for communicating this image data after a predetermined signal process is performed on the image data for communication; and image output means for printing (typing out) and outputting (printing out) this image data.

As described above, the present invention is exemplified by the use of its preferred Embodiments 1 to 3. However, the present invention should not be interpreted solely based on Embodiments 1 to 3 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 3 of the present invention. Furthermore, it is understood that any patent, any patent application and any references cited in the present specification should be incorporated by reference in the present specification in the same manner as the contents are specifically described therein.

### INDUSTRIAL APPLICABILITY

In the field of: a solid-state image capturing device (e.g., CMOS image sensor) in which a decrease in a sensitivity as an observed portion of an image capturing area moves from a central portion toward a peripheral portion is reduced; a method for manufacturing the solid-state image capturing device; and an electronic information device (e.g., digital camera including digital movie camera and digital still camera, cell phone device and vehicle-mounted camera) using the solid-state image capturing device, according to the present invention, a position of each wiring of a plurality of layers of wirings relative to a unit pixel (light receiving section) can be offset so as to be closer to the center of the image capturing area as an observed portion of the image capturing area moves from the central portion toward the peripheral portion of the image capturing area, without changing a wiring width of the wirings of the plurality of layers of wirings with respect to the uppermost layer at the central portion and at the peripheral portion of an image capturing area. Since an opening of a wiring at the peripheral portion of the image capturing area is not reduced, a decrease in a light receiving sensitivity at the peripheral portion of the image capturing area is suppressed, thereby obtaining a solid-state image capturing device with an excellent luminance shading characteristic.

1. A solid-state image capturing device in which an image capturing area is structured having a plurality of light receiving sections arranged at a top portion of a semi-conductor substrate in a two-dimensional array, a plurality of layers of wirings is provided to avoid areas above the light receiving sections, the plurality of layers of wirings are connected to via contact sections, wherein
an offset amount of a position of each wiring of at least an upper layer of the plurality of layers of wirings relative to a light receiving section increases as an observed portion of the image capturing area moves from a central portion toward a peripheral portion of the image capturing area, such that the plurality of layers of wirings is arranged not to block light incident onto the light receiving sections, and
an offset amount of a position of each via contact section to connected to a wiring of the upper layer relative to a light receiving section increases as an observed portion of the image capturing area moves from the central portion toward the peripheral portion of the image capturing area, such that the via contact sections are arranged not to block light incident onto the light receiving sections.

2. A solid-state image capturing device according to claim 1, wherein a position of each wiring of the upper layer relative to a light receiving section is arranged offset so as to be closer to the center of the image capturing area as an observed portion of the image capturing area moves from the central portion toward the peripheral portion of the image capturing area, and
a position of each via contact section relative to a light receiving section is arranged offset so as to be closer to the center of the image capturing area as an observed portion of the image capturing area moves from the central portion toward the peripheral portion of the image capturing area.

3. A solid-state image capturing device according to claim 1, wherein wirings of the upper layer are arranged in an other direction or in a lattice pattern in a plan view, a position of each wiring of the upper layer relative to the light receiving section is arranged offset in one direction or in a radial direction from the center of the image capturing area in the plan view as an observed portion of the image capturing area moves from the central portion toward the peripheral portion of the image capturing area, and
a position of each via contact section relative to the light receiving section is arranged offset in the one direction or the radial direction from the center of the image capturing area in the plan view as an observed portion of the image capturing area moves from the central portion toward the peripheral portion of the image capturing area, the via contact sections are connected to portions of the wirings of the upper layer arranged in the other direction in the plan view.

4. A solid-state image capturing device according to claim 1, wherein wirings of the upper layer are arranged in one direction or in a lattice pattern in a plan view, a position of each wiring of the upper layer relative to the light receiving section is arranged offset in an other direction or in a radial direction from the center of the image capturing area in the plan view as an observed portion of the image capturing area moves from the central portion toward the peripheral portion of the image capturing area, and
a position of each via contact section relative to the light receiving section is arranged offset in the other direction or the radial direction from the center of the image capturing area in the plan view as an observed portion of the image capturing area moves from the central portion toward the peripheral portion of the image capturing area, the via contact sections are connected to portions of the wirings of the upper layer arranged in the one direction in the plan view.

5. A solid-state image capturing device according to claim 3, wherein an offset amount of the wiring of the upper layer in the one direction in the plan view and an offset amount of the via contact section in the one direction in the plan view match each other.

6. A solid-state image capturing device according to claim 4, wherein an offset amount of the wiring of the upper layer in the other direction in the plan view and an offset amount of the via contact section in the other direction in the plan view match each other.

7. A solid-state image capturing device according to claim 3 or 4, wherein a position of each wiring of a lower layer relative to a light receiving section does not change at the central portion and the peripheral portion of the image capturing area, wirings of the lower layer are connected to the wirings of the upper layer by way of the via contacts.

8. A solid-state image capturing device according to claim 3, wherein wirings of a lower layer are arranged in the one direction in the plan view, the wirings of the lower layer are connected to the wirings of the upper layer by way of the via contacts.

9. A solid-state image capturing device according to claim 3, wherein a length of a wiring of a lower layer in the one direction in the plan view is set at least longer than an offset amount of the wiring of the upper layer in the one direction in the plan view and longer than an offset amount of the via contact section in the one direction in the plan view, wirings of the lower layer are connected to the wirings of the upper layer by way of the via contact sections.

10. A solid-state image capturing device according to claim 4, wherein wirings of a lower layer are arranged in the other direction in the plan view, the wirings of the lower layer are connected to the wirings of the upper layer by way of the via contacts.

11. A solid-state image capturing device according to claim 4, wherein a length of a wiring of a lower layer in the other direction in the plan view is set at least longer than an offset amount of the wiring of the upper layer in the other direction in the plan view and longer than an offset amount of the via contact section in the other direction in the plan view, wirings of the lower layer are connected to the wirings of the upper layer by way of the via contact sections.

12. A solid-state image capturing device according to claim 1, wherein an offset amount of a position of each wiring of a lower layer relative to a light receiving section increases as an observed portion of the image capturing area moves from the central portion toward the peripheral portion of the image capturing area, such that the plurality of layers of wirings is arranged not to block light incident onto the light receiving sections, wirings of the lower layer are connected to the wirings of the upper layer by way of the via contact sections.

13. A solid-state image capturing device according to claim 12, wherein a length of the wiring of a lower layer in the one direction in the plan view is set at least longer than an offset amount of the wiring of the lower layer in the one direction in the plan view, wirings of the lower layer are connected to the wirings of the upper layer by way of the via contact sections.

14. A solid-state image capturing device according to claim 12, wherein a length of the wiring of a lower layer in the other direction in the plan view is set at least longer than an offset amount of the wiring of the lower layer in the other direction in the plan view, wirings of the lower layer are connected to the wirings of the upper layer by way of the via contact sections.

15. A solid-state image capturing device according to claim 1, wherein wirings of a lower layer connected to the wirings of the upper layer by way of the via contact sections include:
portions, a position of each of which relative to a light receiving section is offset as an observed portion of the image capturing area moves from the central portion toward the peripheral portion of the image capturing area; and
portions, a position of each of which relative to the light receiving section does not change at the central portion and the peripheral portion of the image capturing area.

16. A solid-state image capturing device according to claim 15, wherein the portions, a position of each of which does not change at the central portion and the peripheral portion of the image capturing area, protrude from the portions, a position of each of which is offset as an observed portion of the image capturing area moves from the central portion toward the peripheral portion of the image capturing area.

17. A solid-state image capturing device according to claim 1, wherein wirings of a lower layer connected to the wirings of the upper layer by way of the via contact sections include:
portions, a position of each of which relative to a light receiving section is offset in one direction in a plan view as an observed portion of the image capturing area moves from the central portion toward the peripheral portion of the image capturing area; and
portions, a position of each of which relative to the light receiving section is offset in an other direction in the plan view as an observed portion of the image capturing area moves from the central portion toward the peripheral portion of the image capturing area.

18. A solid-state image capturing device according to claim 17, wherein the portions offset in the one direction in the plan view protrude from the portions offset in the other direction in the plan view.

19. A solid-state image capturing device according to claim 1, wherein wirings of a lower layer connected to the wirings of the upper layer by way of the via contact sections include:
portions, a position of each of which relative to a light receiving section is offset in one direction in a plan view as an observed portion of the image capturing area moves from the central portion toward the peripheral portion of the image capturing area; and
portions, a position of each of which relative to the light receiving section is offset in an other direction in the plan view as an observed portion of the image capturing area moves from the central portion toward the peripheral portion of the image capturing area; and
portions, a position of each of which relative to the light receiving section does not change at the central portion and the peripheral portion of the image capturing area.

20. A solid-state image capturing device according to claim 12, wherein a position of each via contact section offset relative to a light receiving section as an observed portion of the image capturing area moves from the central portion toward the peripheral portion of the image capturing area matches a position of each wiring of the lower layer offset relative to the light receiving section as an observed portion of the image capturing area moves from the central portion toward the peripheral portion of the image capturing area.

21. A solid-state image capturing device according to claim 12, wherein an offset amount of a position of each wiring of the upper layer offset in one direction in a plan view relative to a light receiving section as an observed portion of the image capturing area moves from the central portion toward the peripheral portion of the image capturing area matches an offset amount of a position of each via contact section offset in the one direction in the plan view relative to the light receiving section as an observed portion of the image capturing area moves from the central portion toward the peripheral portion of the image capturing area, the via contact sections are connected to portions of the wirings of the upper layer arranged in an other direction in the plan view; and
an offset amount of a position of each wiring of the lower layer connected to the via contact sections offset in the other direction in the plan view relative to the light receiving section as an observed portion of the image capturing area moves from the central portion toward the peripheral portion of the image capturing area matches an offset amount of a position of each via contact section offset in the other direction in the plan view relative to the light receiving section as an observed portion of the image capturing area moves from the central portion toward the peripheral portion of the image capturing area, the via contact sections are connected to portions of the wirings of the lower layer arranged in the one direction in the plan view.

22. A solid-state image capturing device according to claim 12, wherein an offset amount of a position of each wiring of the upper layer offset in an other direction in a plan view relative to a light receiving section as an observed portion of the image capturing area moves from the central portion toward the peripheral portion of the image capturing area matches an offset amount of a position of each via contact section offset in the other direction in the plan view relative to the light receiving section as an observed portion of the image capturing area moves from the central portion toward the peripheral portion of the image capturing area, via contact sections are connected to portions of the wirings of the upper layer arranged in one direction in the plan view; and
an offset amount of a position of each wiring of the lower layer connected to the via contact sections offset in the one direction in the plan view relative to the light receiving section as an observed portion of the image capturing area moves from the central portion toward the peripheral portion of the image capturing area matches an offset amount of a position of each via contact section offset in the one direction in the plan view relative to the light receiving section as an observed portion of the image capturing area moves from the central portion toward the peripheral portion of the image capturing area the via contact sections are connected to portions of the wirings of the lower layer arranged in the other direction in the plan view.

23. A solid-state image capturing device according to claim 17, wherein a length of a portion of the wirings of the lower layer in the one direction of the plan view, in which the position of each of the portions of the lower layer relative to the light receiving section is offset in the other direction in the plan view as an observed portion of the image capturing area moves from the central portion toward the peripheral portion of the image capturing area, is set longer than an offset amount of the position of the via contact section offset in the one direction in the plan view relative to the light receiving section as an observed portion of the image capturing area moves from the central portion toward the peripheral portion of the image capturing area, the wirings of the lower layer connected to wirings of the upper layer by way of the via contact sections.

24. A solid-state image capturing device according to claim 1, wherein the wiring of the upper layer is a wiring of an uppermost layer of a plurality of layers of wirings.

25. A solid-state image capturing device according to claim 24, wherein the wiring of a lower layer is a wiring of a second layer from the top with respect to the wiring of the upper layer when the wiring of the upper layer is a wiring of a first layer from the top.

26. A solid-state image capturing device according to claim 1, wherein wirings of the upper layer are arranged in a lattice pattern, the via contacts are arranged at intersections between one direction of the wirings of the upper layer in a plan view and an other direction of the wirings of the upper layer in the plan view at the central portion of the image capturing area, and
the via contact sections are arranged offset from the intersections as an observed portion of the image capturing area moves from the central portion toward the peripheral portion of the image capturing area.

27. A solid-state image capturing device according to claim 1, wherein a setup is conducted in accordance with a limitation of a mask-making device, the setup including a setting direction of the image capturing area; wiring directions of the plurality of layers of wirings; and an offsetting direction of a position relative to each unit pixel as an observed portion of the image capturing area moves from the central portion toward the peripheral portion of the image capturing area.

28. A solid-state image capturing device according to claim 1, wherein a wiring width of the wiring of the upper layer at the central portion of the image capturing area and a wiring width of the wiring of the upper layer at the peripheral portion of the image capturing match each other.

29. A solid-state image capturing device according to claim 28, wherein a wiring width of the wiring of a lower layer for the wiring of the upper layer at the central portion of the image capturing area matches a wiring width of the wiring of the lower layer for the upper layer at the peripheral portion of the image capturing.

30. A solid-state image capturing device according to claim 1, comprising an on-chip lens on an upper layer side of the plurality of layers of wirings for focusing light onto the light receiving sections, wherein a position of the on-chip lens relative to a light receiving section is offset so as to be closer to the center of the image capturing area as an observed portion of the image capturing area moves from the central portion toward the peripheral portion of the image capturing area.

31. An electronic information device using a solid-state image capturing device according to claim 1 for an image capturing section.

32. A method for manufacturing a solid-state image capturing device according to claim 1, wherein
the solid-state image capturing device is manufactured by conducting a setup in accordance with a limitation of a mask-making device, the setup including a setting direction of the image capturing area; wiring directions of the wirings of the plurality of layers; and an offsetting direction of a position relative to each unit pixel as an observed portion of the image capturing area moves from the central portion toward the peripheral portion of the image capturing area.
